(19) United States
(12) Patent Application Publication
(10) Pub. No.: US 2026/0032703 A1
(43) Pub. Date: Jan. 29, 2026

(54) METHOD AND APPARATUS FOR SIDELINK POSITIONING DESIGN AND RESOURCE ALLOCATION

(71) Applicant: Huawei Technologies Co., Ltd., Shenzhen (CN)

(72) Inventor: George Calcev, Hoffman Estates, IL (US)

(21) Appl. No.: 19/349,697

(22) Filed: Oct. 3, 2025

Related U.S. Application Data
(63) Continuation of application No. PCT/US2024/020728, filed on Mar. 20, 2024.
(60) Provisional application No. 63/494,696, filed on Apr. 6, 2023.

(51) Int. Cl. H04W 72/25; H04L 5/00; H04W 92/18

(52) U.S. Cl. CPC H04W 72/25; H04L 5/0048; H04W 92/18

(57) ABSTRACT

According to embodiments, a second user equipment (UE) receives an SL transmission. The SL transmission includes one or more of dedicated sidelink (SL) control signals and one or more corresponding SL positioning reference signals (PRSs) over resources in a dedicated resource pool. The dedicated resource pool is dedicated for physical sidelink control channel (PSCCH) and SL PRS transmissions. The second UE measures the one or more corresponding SL PRSS.

### CROSS-REFERENCE TO RELATED APPLICATIONS

This application is a continuation of International Application No. PCT/US2024/020728, filed on Mar. 20, 2024, and entitled “Method and Apparatus for Sidelink Positioning Design and Resource Allocation,” which claims priority to U.S. Provisional Patent Application No. 63/494,696, filed on Apr. 6, 2023, and entitled “Method and Apparatus for Sidelink Positioning Design and Resource Allocation,” applications of which are incorporated herein by reference in their entireties.

### TECHNICAL FIELD

The present disclosure relates generally to wireless communications, and, in particular embodiments, to methods and apparatus for sidelink (SL) communications.

### BACKGROUND

The third-generation partnership project (3GPP) has been developing and standardizing several important features with fifth generation (5G) new radio access technology (NR). In Release-16, a work item for NR vehicle-to-everything (V2X) wireless communication with the goal of providing 5G-compatible high-speed reliable connectivity for vehicular communications was completed. This work item provides the basics of NR sidelink communication for applications such as safety systems and autonomous driving. High data rates, low latency, and high reliabilities are some of the key areas investigated and standardized. In Release-17, a work item for Sidelink Enhancement was completed to further enhance the capabilities and performance of sidelink communication. One of the objectives of the work item is to introduce an inter-UE coordination mechanism where one UE shares preferred or non-preferred resource for another UE to use in its resource selection or sends a conflict indication to another UEs if there is a conflict on its reserved resources.

### SUMMARY

Technical advantages are generally achieved, by embodiments of this disclosure which describe methods and apparatus.

According to embodiments, a second user equipment (UE) receives an SL transmission. The SL transmission includes one or more of dedicated sidelink (SL) control signals and one or more corresponding SL positioning reference signals (PRSs) over resources in a dedicated resource pool. The dedicated resource pool is dedicated for physical sidelink control channel (PSCCH) and SL PRS transmissions. The second UE measures the one or more corresponding SL PRSs.

In some embodiments, the second UE may receive the SL transmission in a slot.

In some embodiments, each pair of a dedicated SL control signal and a corresponding SL PRS from the one or more dedicated SL control signals and the one or more corresponding SL PRSs may be sent by a different corresponding transmitting UE.

In some embodiments, the slot may include one or more PSCCHs mapped to the one or more corresponding PRSs. Resource allocation of the one or more PSCCHs may be associated with resource allocation of the one or more corresponding SL PRSs. For example, resource allocation of the one or more PSCCHs may be dependent on resource allocation of the one or more corresponding SL PRSs. Or, resource allocation of the one or more corresponding SL PRSs may be dependent on resource allocation of the one or more PSCCHs.

In some embodiments, mappings between the one or more PSCCHs and the one or more corresponding SL PRSs may be pre-configured or configured.

In some embodiments, the second UE may determine a first SL PRS resource for receiving a first SL PRS from a first UE based on the mappings and a first PSCCH resource for receiving a first PSCCH of the one or more PSCCHs from the first UE.

In some embodiments, the one or more dedicated SL control signals may include a first SL control signal from a first UE. The first SL control signal may include a trigger indication. The second UE may transmit a second SL PRS to the first UE based on the trigger indication.

In some embodiments, the second UE may report a measurement report. The measurement report indicating a relative time difference based on the measuring the one or more corresponding SL PRSs and a synchronization source type.

In some embodiments, each of the one or more corresponding SL PRSs may occupy respective continuous symbols, and the respective continuous symbols may be preceded by a corresponding automatic generation control (AGC) symbol.

In some embodiments, a received power of an SL signal may be based on a transmission power of a previous SL PRS transmitted by the second UE to the first UE.

According to embodiments, a first user equipment (UE) generates a dedicated sidelink (SL) control signal and a first SL positioning reference signal (PRS). The first UE transmits, to a second UE, an SL transmission. The SL transmission is over resources in a dedicated resource pool. The dedicated resource pool is dedicated for physical sidelink control channel (PSCCH) and SL PRS transmissions. The SL transmission includes the dedicated SL control signal and the first SL PRS.

In some embodiments, the first UE may transmit the SL transmission in a slot.

In some embodiments, the resources may include a first SL PRS resource for transmitting the first SL PRS and a first PSCCH resource for transmitting the dedicated SL control signal. A mapping between the first SL PRS resource and the first PSCCH resource may be pre-configured or configured.

In some embodiments, the first SL PRS may occupy continuous symbols. The continuous symbols in the SL transmission may be preceded by an automatic generation control (AGC) symbol in the SL transmission.

In some embodiments, the dedicated SL control signal may include a trigger indication for triggering the second UE to send a second SL PRS to the first UE.

In some embodiments, the first UE may transmit to the second UE an SL signal. A transmission power of the SL signal may be based on a received power of a previous SL PRS received by the first UE from the second UE.

In some embodiments, the first UE may receive a measurement report. The measurement report may indicate a relative time difference based on the measuring and a synchronization source type. The first UE may perform sidelink positioning based on the relative time difference indicated by the measurement report.

According to embodiments, a first user equipment (UE) receives sidelink (SL) positioning reference signal (PRS) resource reservations from a second UE. The first UE selects reserved SL resources from SL PRS resources based on the SL PRS resource reservations. The first UE transmits, to the second UE, an SL PRS over the reserved SL resources.

In some embodiments, the reserved SL resources may indicate at least one of a sequence of symbols in a slot or a frequency distribution of the SL PRS. The frequency distribution of the SL PRS may include a comb distribution of SL PRS.

In some embodiments, the reserved SL resources may be selected based on a congestion control metric. The congestion control metric may be based on a ratio of the SL PRS resources over available resources.

According to embodiments, a second UE transmits, to a first UE, sidelink (SL) positioning reference signal (PRS) resource reservations. The second UE receives, from the first UE, an SL PRS over reserved SL resources. The reserved SL resources from SL PRS resources are indicated by the SL PRS resource reservations.

In some embodiments, the reserved SL resources may indicate at least one of a sequence of symbols in a slot or a frequency distribution of the SL PRS. The frequency distribution of the SL PRS may include a comb distribution of SL PRS.

In some embodiments, the reserved SL resources may be selected based on a congestion control metric. The congestion control metric may be based on a ratio of the SL PRS resources over available resources.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows examples of in-coverage and out-of-coverage operations, according to some embodiments;

FIG. 2 illustrates an example of a resource pool in the time-frequency resource grid, according to some embodiments;

FIG. 3 shows an example of a resource grid with PSCCH, PSSCH and PSFCH resources, according to some embodiments;

FIG. 4 shows an example structure of an S-SSB Block, according to some embodiments;

FIG. 5 shows an example UL SRS, according to some embodiments;

FIG. 6 shows an example of DL PRS, according to some embodiments;

FIG. 7 shows an example of timing information on the sensing and resource selection for sidelink transmission, according to some embodiments;

FIG. 8 shows general illustration of sidelink positioning, according to some embodiments;

FIG. 9 shows an example of RTT based ranging in sidelink, according to some embodiments;

FIGS. 10A-10C shows examples of messages flow in RTT based SL ranging, according to some embodiments;

FIG. 11 shows an example of out of order multi-RTT, according to some embodiments;

FIG. 12 shows an example FDM slot format, according to some embodiments;

FIG. 13 shows an example TDM slot format, according to some embodiments;

FIG. 14 shows an example slot format as additional information in SCI carried by a PSCCH, according to some embodiments;

FIG. 15 shows an example of another possible slot format, according to some embodiments;

FIG. 16 shows an example flowchart of SL-PRS resource selection, according to some embodiments;

FIGS. 17A-17B shows the example flowcharts for multi-RTT resource allocation usage and timer expiration, according to some embodiments;

FIG. 18A shows a flow chart of a method performed by a UE, according to some embodiments;

FIG. 18B shows a flow chart of a method performed by a UE, according to some embodiments;

FIG. 18C shows a flow chart of a method performed by a UE, according to some embodiments;

FIG. 18D shows a flow chart of a method performed by a UE, according to some embodiments;

FIG. 19 illustrates an example communications system, according to embodiments;

FIG. 20 illustrates an example communication system, according to some embodiments;

FIGS. 21A and 21B illustrate example devices that may implement the methods and teachings according to this disclosure; and

FIG. 22 is a block diagram of a computing system that may be used for implementing the devices and methods disclosed herein.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

In Release-16, a work item for NR positioning support was completed, which provides positioning support in 5G NR including downlink (DL) and uplink (UL) reference signals for various positioning techniques (e.g., DL-time difference of arrival (TDOA), DL-angle of departure (AoD), UL-TDOA, UL-angle of arrival (AoA), multi-cell round trip time (RTT), and Enhanced Cell-ID (E-CID)), as well as the UE and gNB measurements for NR positioning. In Release-17, a work item for NR Positioning Enhancements with the goal of supporting high accuracy, low latency, network efficiency, and device efficiency was completed. This work item provides methods, measurements, signaling, and procedures for improving positioning accuracy over Release-16 positioning methods.

In Release-18, a study item on expanded and improved NR positioning was approved which includes the study of sidelink positioning solutions.

Embodiments of this disclosure provide new techniques and signaling to enable sidelink positioning.

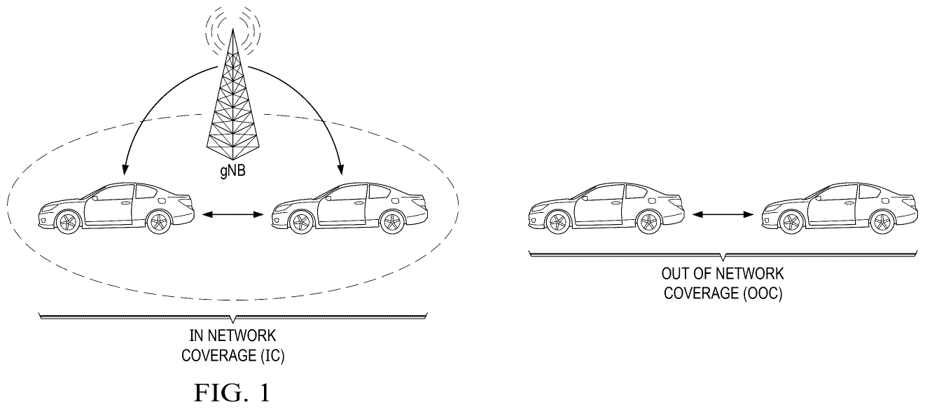

Sidelink communication can either be in-coverage, or out-of-coverage. FIG. 1 shows examples of in-coverage and out-of-coverage operations. With in-coverage (IC) operation, a central node (e.g., eNB or gNB) is present and can be used to manage the sidelink (mode 1/scheme 1). In mode 2/scheme 2 operation, system operation is fully distributed, and UEs select resources on their own. In this disclosure, some UEs could also be facilitated/assisted in selecting their resources. In mode 2, UEs can be either in-coverage or out-of-coverage (OOC).

For the purposes of sidelink communications, the notion of resource pools was introduced for the LTE sidelink and is reused for NR sidelink. A resource pool can be a set of resources that can be used for sidelink communication. Resources in a resource pool are configured for different channels including control channels, shared channels, feedback channels, synchronization signals, reference signals, broadcast channels (e.g. master information block), and so on. The 3GPP standard (TS 38.214) defines procedures on how the resources are shared and used for a particular configuration of the resource pool.

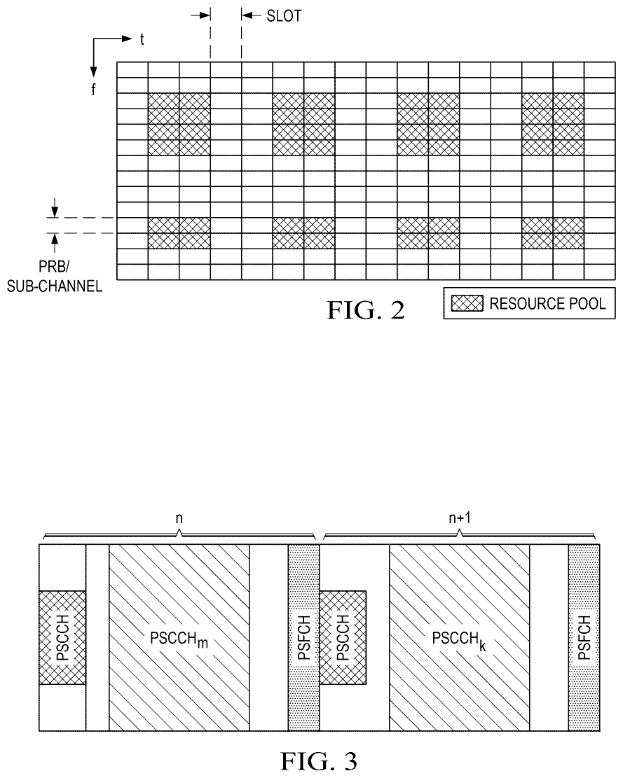

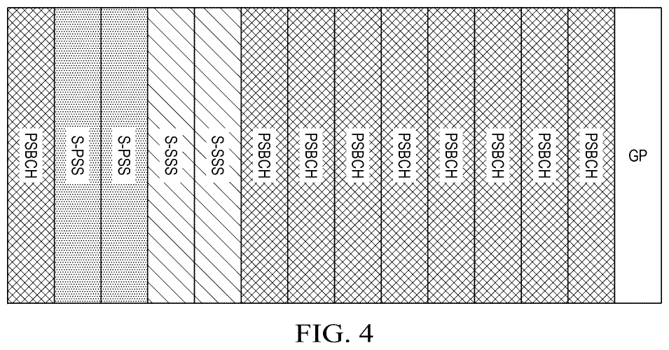

A resource pool for sidelink can be configured in units of slots in the time domain and physical resource blocks (PRBs) or sub-channels in the frequency domain. A sub-channel includes one or more PRBs. FIG. 2 illustrates an example of a resource pool in the time-frequency resource grid. FIG. 3 shows an example of a resource grid with PSCCH, PSSCH and PSFCH resources in it.

For NR mobile broadband (MBB), each physical resource block (PRB) in the grid is defined as a slot of 14 consecutive orthogonal frequency division multiplexing (OFDM) symbols in the time domain and 12 consecutive subcarriers in the frequency domain, i.e., each resource block contains 12×14 resource elements (REs) (when used as a frequency-domain unit, a PRB is 12 consecutive subcarriers). There are 14 symbols in a slot when a normal cyclic prefix (CP) is used and 12 symbols in a slot when an extended cyclic prefix (ECP) is used. The duration of a symbol is inversely proportional to the subcarrier spacing (SCS). For example, for a {15, 30, 60, 120} kHz SCS, the duration of a slot may be {1, 0.5, 0.25, 0.125} ms, respectively. Each PRB may be allocated to combinations of a control channel (CCH), a shared channel (SCH), a feedback channel, reference signals (RS), and so on. In addition, some REs of a PRB may be reserved. A communication resource may occupy a PRB, a set of PRBs, and use a code (if code-division multiple access (CDMA) is used, similarly as for the physical uplink control channel (PUCCH)), a physical sequence, a set of REs, and so on.

The physical sidelink control channel (PSCCH) carries the sidelink control information (SCI). The source UE uses the SCI to schedule the transmission of data on the physical sidelink shared channel (PSSCH). The SCI can indicate the time and frequency resources of the PSSCH. The SCI can further indicate parameters for hybrid automatic repeat request (HARQ) process (such as the redundancy version, process id, new data indicator, and resources for the physical sidelink feedback channel (PFSCH)). The PFSCH can carry an indication (HARQ-ACK) of whether the recipient (destination) UE decoded the payload carried on PSSCH correctly (e.g. an acknowledgement or negative acknowledgement (ACK/NACK)). The SCI can also carry a bit field indicating a representation of the identity of the source UE. In addition, the SCI can also carry a bit field indicating a representation of the identity of the destination UE(s). Other fields include the modulation coding scheme (MCS) used to encode the payload and modulate the coded payload bits; the demodulation reference signal (DMRS) pattern, the antenna ports, and priority of the payload (transmission).

The NR sidelink control information (SCI) can be transmitted in two stages: e.g., a first stage (shown below) with SCI Format 1-A and a second stage with SCI Formats 2-A, B or C. The first stage indicates the resources for the second stage SCI.

SCI format 1-A (from TS 38.212) is used for the scheduling of PSSCH and 2nd-stage-SCI on PSSCH.

The following information is transmitted by means of the SCI format 1-A:
Priority-3 bits as defined in clause 5.4.3.3 of TS 23.287

$$Frequency resource assignment - ⌈ {log}_{2} ( \frac{{N}_{subChannel}^{SL} ( {N}_{subChannel}^{SL} + 1 )}{2} ) ⌉ bits$$

when the value of the higher layer parameter sl-MaxNumPerReserve is configured to 2; otherwise

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits$$

when the value of the higher layer parameter sl-MaxNumPerReserve is configured to 3, as defined in clause 8.1.2.2 of TS 38.214
Time resource assignment—5 bits when the value of the higher layer parameter sl-MaxNumPerReserve is configured to 2; otherwise 9 bits when the value of the higher layer parameter sl-MaxNumPerReserve is configured to 3, as defined in clause 8.1.2.1 of TS 38.214
Resource reservation period—┌log₂ Nrsv_period┐ bits as defined in clause 8.1.4 of TS 38.214, where N_{rsv_period} is the number of entries in the higher layer parameter sl-ResourceReservePeriodList, if higher layer parameter sl-MultiReserveResource is configured; 0 bit otherwise
DMRS pattern—┌log₂ Nₚₐₜₜₑᵣₙ┐ bits as defined in clause 8.4.1.1.2 of TS 38.211, where Nₚₐₜₜₑᵣₙ is the number of DMRS patterns configured by higher layer parameter sl-PSSCH-DMRS-TimePatternList; 0 bit if sl-PSSCH-DMRS-TimePatternList is not configured
2nd-stage SCI format—2 bits as defined in Table 8.3.1.1-1 of TS 38.212
Beta_offset indicator—2 bits as provided by higher layer parameter sl-BetaOffsets2ndSCI and Table 8.3.1.1-2 of TS.38.212
Number of DMRS port—1 bit as defined in Table 8.3.1.1-3 of TS 38.212
Modulation and coding scheme—5 bits as defined in clause 8.1.3 of TS 38.214
Additional MCS table indicator—as defined in clause 8.1.3.1 of TS 38.214:1 bit if one MCS table is configured by higher layer parameter sl-Additional-MCS-Table; 2 bits if two MCS tables are configured by higher layer parameter sl-Additional-MCS-Table; 0 bit otherwise
PSFCH overhead indication—1 bit as defined clause 8.1.3.2 of TS 38.214 if higher layer parameter sl-PSFCH-Period=2 or 4; 0 bit otherwise
Reserved—a number of bits as determined by higher layer parameter sl-NumReservedBits, with value set to zero.

SCI format 2-A (from TS 38.212) is used for the decoding of PSSCH, with HARQ operation when HARQ-ACK information includes ACK or NACK, or when there is no feedback of HARQ-ACK information.

The following information is transmitted by means of the SCI format 2-A as defined in clause 8.4.1.1 of TS 38.212:

$$HARQ process number - ⌈ {log}_{2} {N}_{process} ⌉ bits$$

New data indicator—1 bit
Redundancy version—2 bits as defined in Table 7.3.1.1.1-2 of TS 38.212
Source ID—8 bits as defined in clause 8.1 of TS 38.214
Destination ID—16 bits as defined in clause 8.1 of TS 38.214
HARQ feedback enabled/disabled indicator—1 bit as defined in clause 16.3 of TS 38.213
Cast type indicator—2 bits as defined in Table 8.4.1.1-1 of TS 38.212
CSI request—1 bit as defined in clause 8.2.1 of TS 38.214.

TABLE 1
Cast type indicator (from Table 8.4.1.1-1)

| Value of Cast type | |
|---|---|
| indicator | Cast type |
| 00 | Broadcast |
| 01 | Groupcast |
| 10 | Unicast |
| 11 | Reserved |

SCI format 2-B (from TS 38.212) is used for the decoding of PSSCH, with HARQ operation when HARQ-ACK information includes only NACK, or when there is no feedback of HARQ-ACK information.

The following information is transmitted by means of the SCI format 2-B as defined in the clause 8.4.1.2 of TS 38.212:
HARQ process number—┌log₂ N_{process}┐ bits
HARQ process number—┌log₂ N_{process}┐ bits
New data indicator—1 bit
Redundancy version—2 bits as defined in Table 7.3.1.1.1-2 of TS 38.212
Source ID—8 bits as defined in clause 8.1 of TS 38.214
Destination ID—16 bits as defined in clause 8.1 of TS 38.214
HARQ feedback enabled/disabled indicator—1 bit as defined in clause 16.3 of TS 38.213
Zone ID—12 bits as defined in clause 5.8.1.1 of TS 38.331
Communication range requirement—4 bits.

Higher layer messages (from TS 38.331) are shown below.

| | |
|---|---|
| SL-PSCCH-Config-r16 ::= | SEQUENCE { |
| sl-TimeResourcePSCCH-r16 | ENUMERATED {n2, n3} |

OPTIONAL, -- Need M

| | |
|---|---|
| sl-FreqResourcePSCCH-r16 | ENUMERATED {n10,n12, n15, n20, n25} |

OPTIONAL, -- Need M

| | |
|---|---|
| sl-DMRS-ScrambleID-r16 | INTEGER (0..65535) |

OPTIONAL, -- Need M

| | | |
|---|---|---|
| sl-NumReservedBits-r16 | INTEGER (2..4) | OPTIONAL, -- |

Need M
...
}

TABLE 2
SL-PSCCH field descriptions

sl-FreqResourcePSCCH
Indicates the number of PRBs for PSCCH in a resource pool where it is
not greater than the number PRBs of the subchannel.
sl-DMRS-ScrambleID
Indicates the initialization value for PSCCH DMRS scrambling.
sl-NumReservedBits
Indicates the number of reserved bits in first stage SCI.
sl-TimeResourcePSCCH
Indicates the number of symbols of PSCCH in a resource pool.

SCI format 2-C (from TS 38.212) is used for the decoding of PSSCH, and providing inter-UE coordination information or requesting inter-UE coordination information.

The following information is transmitted by means of the SCI format 2-C as defined in clause 8.4.1.3 of TS 38.212:
HARQ process number—4 bits
New data indicator—1 bit
Redundancy version—2 bits as defined in Table 7.3.1.1.1-2 of TS 38.212
Source ID—8 bits as defined in clause 8.1 of TS 38.214
Destination ID—16 bits as defined in clause 8.1 of TS 38.214
HARQ feedback enabled/disabled indicator—1 bit as defined in clause 16.3 of TS 38.213
CSI request—1 bit as defined in clause 8.2.1 of TS 38.214 and in clause 8.1 of TS 38.214
Providing/Requesting indicator—1 bit, where value 0 indicates SCI format 2-C is used for providing inter-UE coordination information and value 1 indicates SCI format 2-C is used for requesting inter-UE coordination information.

If the ‘Providing/Requesting indicator’ field is set to 0, all the remaining fields are set as follows:

$$Resource combinations - 2 \cdot ( ⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ + 9 + Y ) bits$$

as defined in Clause 8.1.5A of TS 38.214, where
Y=┌log₂ N_{rsv_period}┐ and N_{rsv_period} is the number of entries in the higher layer parameter sl-ResourceReservePeriodList, if higher layer parameter sl-MultiReserveResource is configured; Y=0 otherwise
N_{subChannel}^{SL} is the number of subchannels in a resource pool provided by the higher layer parameter sl-NumSubchannel
First resource location—8 bits as defined in Clause 8.1.5A of TS 38.214
Reference slot location—(10+┌log₂(10·2^{μ})┐) bits as defined in Clause 8.1.5A of TS 38.214, where μ is defined in Table 4.2-1 of Clause 4.2 of TS 38.211
Resource set type—1 bit, where value 0 indicates preferred resource set and value 1 indicates non-preferred resource set

$$Lowest subChannel indices - 2 \cdot ⌈ {log}_{2} {N}_{subChannel}^{SL} ⌉ bits$$

as defined in Clause 8.1.5A of TS 38.214.

If the ‘Providing/Requesting indicator’ field is set to 1, all the remaining fields are set as follows:
Priority—3 bits as specified in clause 5.4.3.3 of TS 23.287 and clause 5.22.1.3.1 of TS 38.321. Value ‘ooo’ of Priority field corresponds to priority value ‘1’, value ‘001’ of Priority field corresponds to priority value ‘2’, and so on

$$Number of subchannels - ⌈ {log}_{2} {N}_{subChannel}^{SL} ⌉ bits$$

as defined in Clause 8.1.4A of TS 38.214
Resource reservation period—┌log₂ N_{rsv_period}┐ bits as defined in Clause 8.1.4A of TS 38.214, where N_{rsv_period} is the number of entries in the higher layer parameter sl-ResourceReservePeriodList, if higher layer parameter sl-MultiReserveResource is configured; 0 bit otherwise
Resource selection window location—2·(10 +┌log₂(10·2^{μ})┐) bits as defined in Clause 8.1.4A of TS 38.214, where p is defined in Table 4.2-1 of Clause 4.2 of TS 38.211
Resource set type—1 bit, where value o indicates a request for inter-UE coordination information providing preferred resource set and value 1 indicates a request for inter-UE coordination information providing non-preferred resource set, if higher layer parameter determine ResourceSetTypeSchemei is configured to ‘UE-B's request’; otherwise, 0 bit
Padding bits.

In Rel-17, sidelink inter-UE coordination (IUC) is specified to improve mode 2 reliability by overcoming the issues such as hidden-node, exposed-node, and half-duplex, that impact sidelink performance. Two IUC schemes were defined: i.e.,
Scheme 1: inter-UE coordination information signaling from UE-A to UE-B
   Set of resources preferred for UE-B's transmission
   Set of resources not preferred for UE-B's transmission
Scheme 2: inter-UE coordination information signaling from UE-A to UE-B
   Presence of expected/potential resource conflict on the resources indicated by UE-B's SCI

In IUC Scheme 1, two IUC triggering scenarios were considered and specified. In the first scenario, the coordination is triggered by an explicit request where UE-B sends explicit request to UE-A and UE-A, upon request, generates and sends the coordination information (preferred resource set or non-preferred resource set) to UE-B. In the second scenario, the coordination is triggered by a condition other than an explicit request where a UE (e.g., UE-A) that satisfies certain condition(s) generates and sends coordination information to UE-B.

The conditions for the two IUC triggering scenarios are also specified. For IUC triggered by an explicit request, one of the two conditions is configured at the resource pool level (i.e., alternative 1 is up to UE-B's implementation and for alternative 2, the request can be triggered only when UE-B has data to be transmitted to UE-A). Similarly, for IUC triggered by a condition, two conditions are agreed with one of them enabled by the resource pool level (pre-configuration (i.e., alternative 1 is up to UE-A's implementation, and for alternative 2, the coordination can be triggered only when UE-A has data to be transmitted together with coordination information to UE-B).

The criteria for generating the coordination information (i.e., preferred resource set and/or non-preferred resource set) are defined as follows.
Preferred resource set:
   Condition 1-A-1: Resource(s) excluding the overlapped reserved resource(s) of other UE with RSRP larger than a threshold.
   Condition 1-A-2: Resource(s) excluding the slots when UE-A, as Rx of UE-B, does not expect to perform SL reception from UE-B
Non-preferred resource set:
   Condition 1-B-1: Reserved resource(s) of other UE identified by and RSRP measurement.
      Option 1: Reserved resource(s) of other UE(s) identified by UE-A whose RSRP measurement is larger than a (pre) configured RSRP threshold.
      Option 2: Reserved resource(s) of other UE identified by UE-A whose RSRP measurement is smaller than a (pre) configured RSRP threshold when UE-A is a destination of a TB transmitted by the UE(s)
   Condition 1-B-2: Resource(s) (e.g., slot(s)) where UE-A, when it is intended receiver of UE-B, does not expect to perform SL reception from UE-B

To send explicit request and coordination information, a MAC-CE may be used as the container. If configured, the second stage SCI, SCI-2C, may also be used for explicit request or coordination information.

For coordination triggered by an explicit request, only unicast may be supported for both transmissions of explicit request and coordination information. For coordination triggered by a condition, unicast is supported for transmission of both types of coordination information. Broadcast and groupcast may be supported for non-preferred resource set only.

The coordination information and explicit request can be transmitted multiplexed with data only if source/destination ID pair is the same.

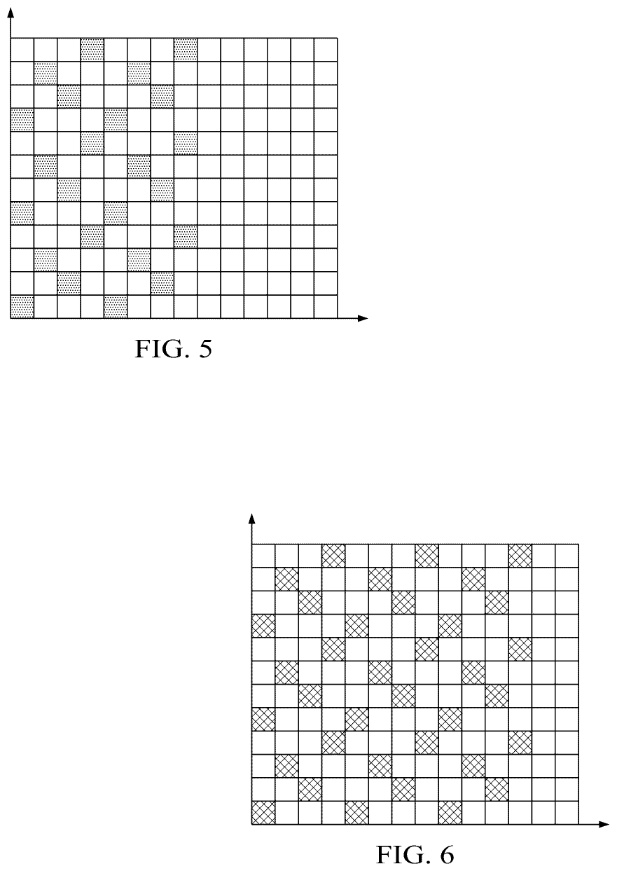

A synchronization slot in the sidelink (i.e., Sidelink Synchronization Signal Block (S-SSB)) may be specified for one UE to synchronize with another UE. As shown in FIG. 4, the first OFDM symbol in the structure of an S-SSB is for a physical sidelink broadcast channel (PSBCH). But like the regular sidelink slot, the first symbol is for settling the automatic generation control (AGC), after which there are two symbols for the sidelink primary synchronization signal (S-PSS) and two symbols for the sidelink secondary synchronization signal (S-SSS). Eight of the remaining nine symbols are for PSBCH transmission. The last symbol is a guard period (GP), same as in the regular sidelink slot.

In the frequency domain, the S-SSB occupies 11 PRBs with a total of 132 subcarriers. PSBCH occupies all 11 PRBs while the size of synchronization signal is 127. Thus, the S-PSS and the S-SSS occupy 127 subcarriers.

The periodicity of S-SSB is 160 ms. The frequency location of the S-SSB is pre-configured. The number of S-SSB transmissions is set to 1 for FR1 and is configurable for FR2.

In NR, as specified in TS 38.211, a sounding reference signal (SRS) resource with 1, 2, or 4 antenna ports is supported which can be mapped to

$${N}_{symb}^{SRS} ∈ \{ 1 , 2 , 4 , 8 , 12 \}$$

consecutive OFDM symbols. Comb transmission on every KTC=2 or 4 or 8 REs in the frequency domain is supported. In addition, cyclic shift is supported with the maximum number of cyclic shifts,

$${n}_{SRS}^{cs , max} ,$$

equal to 8, 12, and 6 when size of comb is 2, 4, and 8, respectively. SRS sequence ID is configured by higher layer parameter. The starting OFDM symbol l₀ in the time domain is defined by an offset l_{offset} from the end of the slot, where l_{offset}∈{0, 1, . . . , 13} indicating the starting position can be any OFDM symbol in the slot. The frequency starting position is also specified. For positioning, and additional offset in frequency domain

$${k}_{offset}^{{l}^{′}}$$

was specified which is also dependent of the OFDM symbol configured for SRS transmissions. An SRS resource may be configured for periodic, semi-persistent, aperiodic SRS transmission. In the frequency domain, SRS allocation is aligned with the 4 PRB grid. Frequency hopping is supported as in the case of LTE. With same design approach, NR SRS bandwidth and hopping configuration are designed to cover a larger span of values compared to that of LTE.

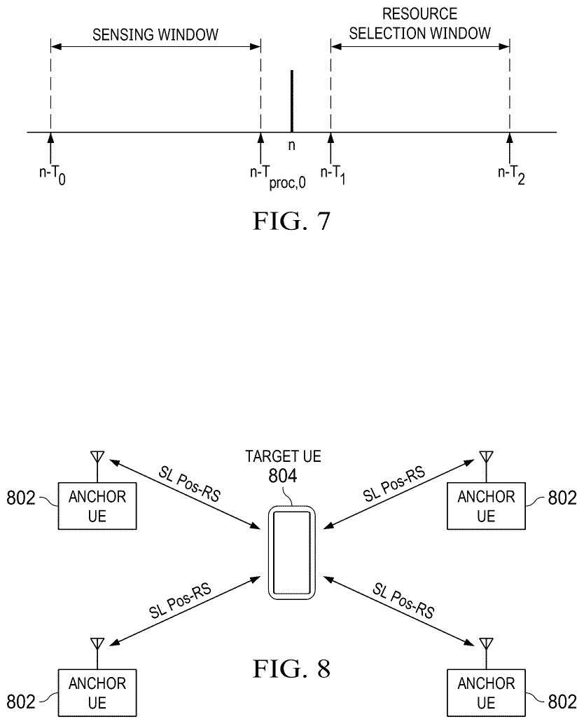

As specified in TS 38.211, an SRS resource is configured by the SRS-Resource information element (IE) for UL channel sounding or the SRS-PosResource IE for positioning purposes. FIG. 5 shows an example UL SRS with comb size KTC=4 on

$${N}_{symb}^{SRS} = 8 OFDM$$

symbols in a slot.

The UE can be configured with one or more SRS resource sets. For each SRS resource set, a UE may be configured with a number of SRS resources. The use case (such as beam management, codebook-based uplink MIMO, and non-codebook-based uplink MIMO, and antenna switching which actually is for general downlink channel state information (CSI) acquisition) for an SRS resource set is configured by the higher layer parameter.

In the time domain at slot level, an SRS resource can be configured periodically with a periodicity T_{SRS} (in slots) and slot offset T_{offset}.

TABLE 3
(from TS 38.211, Table 6.4.1.4.2-1:
$Maximum number of cyclic shifts {n}_{SRS}^{cs , max} as a$
function of K_{TC})

| KTC | ${n}_{SRS}^{cs , max}$ |
|---|---|
| 2 | 8 |
| 4 | 12 |
| 8 | 6 |

TABLE 4
$( from TS 38.211 , Table 6.4 \text{.1} \text{.4} \text{.3} - 2 : The offset {k}_{offset}^{{l}^{′}} for SRS as a function of {K}_{TC} and {l}^{′} )$

| | ${k}_{offset}^{0} , ... , {k}_{offset}^{{N}_{symb}^{SRS} - 1}$ | | | | |
|---|---|---|---|---|---|
| K_{TC} | ${N}_{symb}^{SRS} = 1$ | ${N}_{symb}^{SRS} = 2$ | ${N}_{symb}^{SRS} = 4$ | ${N}_{symb}^{SRS} = 8$ | ${N}_{symb}^{SRS} = 12$ |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, 0, 2, 1, 3 |
| 8 | — | — | 0, 4, 2, 6 | 0, 4, 2, 6, 1, 5, 3, 7 | 0, 4, 2, 6, 1, 5, 3, 7, 0, 4, 2, 6 |

The positioning reference signal (PRS) is a downlink reference signal for positioning purposes. PRS is also called DL-PRS while the UL SRS configured for positioning is sometimes called UL-PRS.

DL-PRS is specified with a starting symbol

$${l}_{start}^{PRS} ∈ \{ 0 , ... , 12 \} ,$$

the size (number of OFDM symbols) of PRS L_{PRS}∈{2,4,6,12}, the frequency domain interval of two DL-PRS resource-elements (i.e., the comb size)

$${K}_{comb}^{PRS} ∈ \{ 2 , 4 , 6 , 12 \}$$

which is selected from a specified subset of

$$\{ {L}_{PRS} , {K}_{comb}^{PRS} \}$$

combinations, the initial frequency domain offset

$${k}_{offset}^{PRS} ∈ \{ 0 , 1 , ... , {K}_{comb}^{PRS} - 1 \} ,$$

and, similarly as the UL-SRS for positioning, an additional frequency domain offset k′ specified in a table (Table 7.4.1.7.3-1 of TS 38.211) which varies over OFDM symbol to symbol.

TABLE 5
$( from TS 38.211 , Table 7.4 \text{.1} \text{.7} \text{.3} - 1 : The frequency offset {k}^{′} as a function of l - {l}_{start}^{PRS} )$

| | Symbol number within the downlink PRS resource l - | | | | | | | | | | | |
|---|---|---|---|---|---|---|---|---|---|---|---|---|
| | ${l}_{start}^{PRS}$ | | | | | | | | | | | |
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

In the time domain at the slot level, DL-PRS can be configured with a periodicity

$${T}_{per}^{PRS} ∈ {2}^{μ} \{ 4 , 5 , 8 , 10 , 16 , 20 , 32 , \\ 40 , 64 , 80 , 160 , 320 , 640 , 1280 , 2560 , 5120 , 10240 \}$$

and a slot offset

$${T}_{offset}^{PRS} ∈ \{ 0 , 1 , ... , {T}_{per}^{PRS} - 1 \} ,$$

as well as an additional slot offset

$${T}_{offset , res}^{PRS} .$$

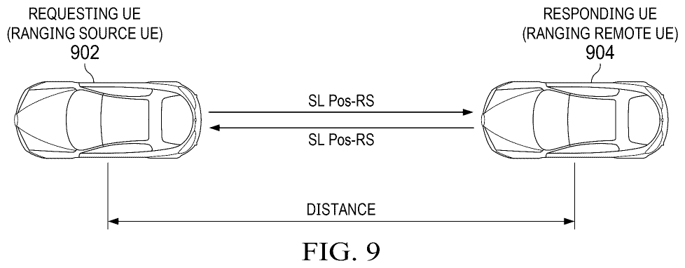

The bandwith of the DL-PRS can be configured in a range from 24 to 272 PRBs with a step of 4 PRBs. FIG. 6 shows an example of DL PRS with comb size

$${K}_{comb}^{PRS} = 4 , {l}_{start}^{PRS} = 0 ,$$

and L_{PRS}=12 OFDM symbols in a slot

The need for 3GPP to develop sidelink positioning solutions has been discussed in the 3GPP Rel-18 planning phase. It has been shown that various important use cases can benefit from the SL positioning, such as the V2x and public safety use cases in TR 38.845, ranging-based services in TS 22.261, and IIoT use cases (TS22.104).

At RANP #94, a Rel-18 study item on expanded and improved NR positioning (RP-213588) was agreed, which includes the objective of SL positioning as:
Study and evaluate performance and feasibility of potential solutions for SL positioning, considering relative positioning, ranging and absolute positioning: [RAN1, RAN2]
   Evaluate bandwidth requirement needed to meet the identified accuracy requirements [RAN1]
   Study of positioning methods (e.g., TDOA, RTT, AOA/D, etc.) including combination of SL positioning measurements with other RAT dependent positioning measurements (e.g., Uu based measurements) [RAN1]
   Study of sidelink reference signals for positioning purposes from physical layer perspective, including signal design, resource allocation, measurements, associated procedures, etc., reusing existing reference signals, procedures, etc. from sidelink communication and from positioning as much as possible [RAN1]
   Study of positioning architecture and signaling procedures (e.g. configuration, measurement reporting, etc.) to enable sidelink positioning covering both UE based and network based positioning [RAN2, including coordination and alignment with RAN3 and SA2 as required]

In Rel-16 NR V2X sidelink mode 1, the gNB performs scheduling of the sidelink (i.e., gNB allocates the SL resources for SL communications and the resource allocation is sent to the UE through the NR Uu interface). Therefore, the sidelink mode 1 is applicable to UEs under the coverage of a gNB. The resources allocated with mode-1 can be either on the same carrier as cellular NR or a dedicated sidelink carrier.

There are three types of mode 1 resource allocations: dynamic assignment, type 1 configured grant (CG), and type 2 configured grant. In dynamic assignment, the UE first sends a scheduling request (SR) for every transport block (TB) to the gNB via the PUCCH. Then, gNB sends a SL resource allocation to the UE via downlink control information (DCI) format 3_0 over the PDCCH. In CG based resource allocation, UE first sends a message to the gNB with the expected SL traffic (e.g., periodicity, the TB maximum size, and QoS information). The gNB provides resource allocation (e.g., a CG to the UE that the gNB provides by RRC signaling). In type 1 CG, the UE can use the resource allocation immediately. In type 2 CG, the UE uses the allocated resources only after activation by gNB via a DCI.

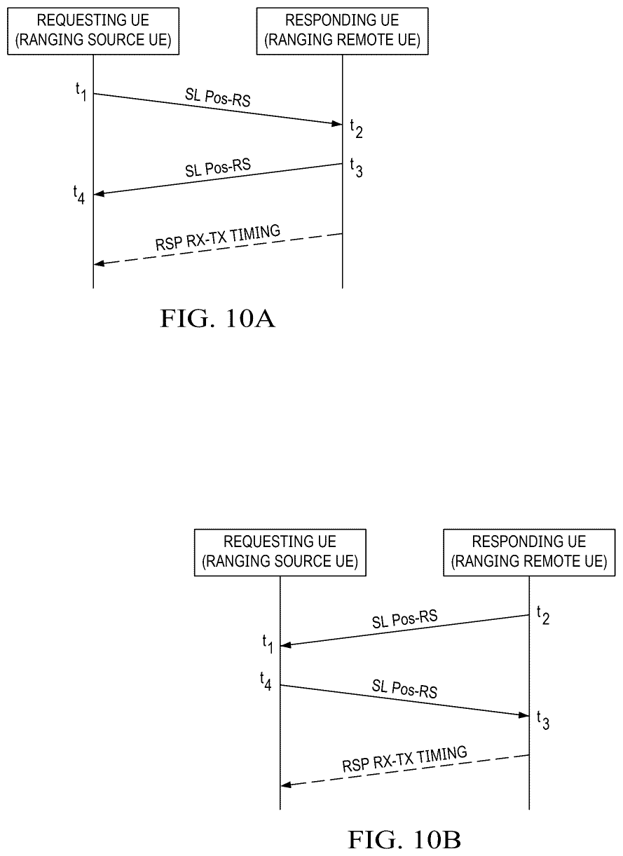

In Rel-16 sidelink, mode 2 UEs transmit and receive information without the need of the network management. UEs themselves allocate the resources from a resource pool for sidelink transmissions. Resource allocation relies on a sensing and reservation process as shown in FIG. 7. During the sensing procedure, a monitoring UE detects SCI transmitted in each slot in the sensing window and measures RSRP of the resource indicated in the SCI. A monitoring UE may also receive transmissions of data (i.e., also being a receiving UE). For periodic traffic, the resource reservations for sidelink transmissions, if a UE occupies a resource on slot sk, it may also occupy the resource on slot sk+q*RRIk, where q is an integer, RRIk is resource reservation interval for UE m that the sensing UE detected. Detecting the SCI includes the steps of receiving and decoding the PSCCH and processing the SCI within the PSCCH.

For aperiodic or dynamic transmissions, the transmitting UE reserves multiple resources and indicates the next resource in the SCI. Therefore, based on the sensing results, a monitoring UE can determine which resources may be occupied in the future and can avoid them for its own transmission if the measured RSRP on the occupied resource during the sensing period is above the RSRP threshold in the resource exclusion procedure, as described in TS 38.214.

FIG. 7 shows the timing information on the sensing and resource selection for Rel-16 NR sidelink transmission, which is usually referred as full sensing. When resource selection is triggered on slot n, based on sensing results in the sensing window, i.e., on slots [n-T0, n-Tproc,0], the transmitting UE selects the resources in the resource selection window in a resource pool, i.e., on slots [n+T1, n+T2], where
T₀: number of slots with the value determined by resource pool configuration.
T_{proc,0}: time required for a UE to complete the sensing process.
T₁: processing time required for identification of candidate resources and resource selection

$${T}_{1} \leq {T}_{proc , 1} ;$$

T₂: the last slot of resource pool for resource selection which is left to UE implementation but in the range of ┌T₂ₘᵢₙ, PDB┐ where T₂ₘᵢₙ is minimum value of T₂ and PDB denotes packet delay budget, the remaining time for UE transmitting the data packet.
T_{proc,1}: maximum time required for a UE to identify candidate resources and select new sidelink resources.

Several positioning methods have been agreed in NR (TS 38.305) which include DL based solutions, UL based solutions, and DL and UL based solutions.

In DL based solutions, the timing based techniques include Downlink Time Difference of Arrival (DL-TDOA). Like OTDOA in LTE, NR specified DL-TDOA positioning which measures the timing difference of DL-PRS on LOS paths from different gNBs.

In DL based solutions, angle-based techniques include Downlink angle(s) of departure (DL-AOD). NR introduces new angle-based positioning techniques. In DL-AOD, the UE measures the received power based on DL-PRS and estimates the AOD from different gNBs based on the measured power difference among PRS/beam from the same TRP.

In UL based solutions, timing based techniques include Uplink Time Difference of Arrival (UL-TDOA). Different from LTE, NR introduced a UL positioning technique using an UL positioning signal which is configured UL SRS. The gNBs measure the UL timing difference from the UE.

In UL based solutions, angle-based techniques include Uplink angle(s) of arrival (UL-AOA). Similar to DL-AOD, gNBs measures the AOA from the UE using the UL SRS configured for positioning purposes. The gNBs measure both zenith AOA and azimuth AOA to obtain a 3D location.

In DL and UL based solutions, timing based techniques include multi-cell round trip time (multi-RTT). In multi-RTT, the UE measures the UE Rx-Tx time difference and gNBs measures the gNB Rx-Tx time difference. The RTT can be estimated with two Rx-Tx time differences for each UE-gNB pair. For Rx-Tx time difference measurement, DL PRS and UL SRS are configured and transmitted from gNBs and the UE, respectively.

Enhanced Cell-ID (E-CID) based positioning is based on radio resource management (RRM) measurements (e.g., RSRP, RSRQ, via synchronization signals (i.e., SSB measurement) and CSI-RS). UL AOA is also supported.

The positioning method selection, configuration of the reference signals (SRS, PRS), and collection of the measurements may be orchestrated by the Location Management Function (LMF) that resides in the network (TS 38.305). The LMF manages the support of different location services for target UEs, including positioning of UEs and delivery of assistance data to UEs. The LMF may interact with the serving gNB or serving ng-eNB for a target UE to obtain position measurements for the UE, including uplink measurements made by an NG-RAN and downlink measurements made by the UE that were provided to an NG-RAN as part of other functions such as for support of handover.

For radio access technology (RAT) dependent positioning in cellular system, the procedure was well studied and specified from LTE. For NR positioning, the functions and procedures are mostly like that in LTE. Some new techniques and UL reference signal are introduced. However, for SL positioning, although the positioning methods may be reused, the procedures and the reference signaling are not defined yet.

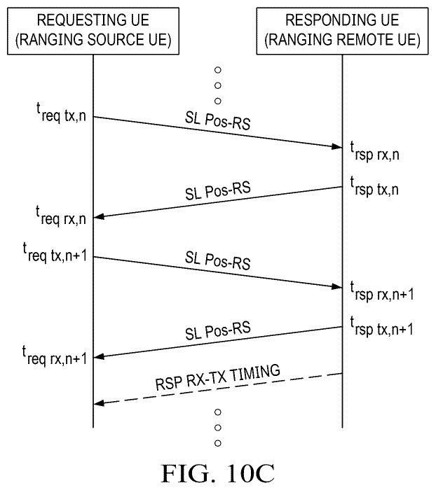

FIG. 8 shows the general illustration of sidelink positioning. As illustrated in FIG. 8, this disclosure considers a sidelink positioning system including multiple location reference UEs (e.g., anchor UEs 802), and a target UE 804. Sidelink positioning is to obtain the position of the target UE 804 based on the location information of the anchor UEs through reference signal measurements exchanged between the target UE and anchor UEs. The reference signaling for SL positioning measurements is denoted as SL positioning reference signals (SL Pos-RS or SL PRS).

In the NR positioning, DL and UL positioning signaling are well synchronized and organized, the network can provide the configurations of the signaling for positioning (e.g., DL PRS or UL SRS), and measurement reporting. Unlike NR Uu link, sidelink transmissions are opportunistic, and multiple transceiver links co-exist in the same resource pool. As described above, to minimize the effects of resource allocation conflicts between different UE-to-UE links which incur the interference, sidelink transmissions are based on resource reservations either through gNB with centralized planning under gNB's coverage (Scheme1, Mode 1) or through UE sensing for Mode 2/Scheme 2. Therefore, the positioning procedure and resource allocations are different in sidelink

This disclosure provides the procedure or protocol design for SL positioning as well as reference signal configurations. Techniques described in this disclosure solve the following technical problems:
Sidelink slot formats that support sidelink positioning reference signals (SL-PRS) for higher capacity using multiplexing in frequency (FDM), and time (TDM),
Signaling that supports FDM and TDM multiplexing, and
Changes to resource selection and reservation to support such formats.

The multi round trip time (RTT) procedure includes consecutive transmissions of SL-PRS between two nodes, where each node measures the Rx-Tx time to estimate the time of flight (ToF). From the ToF estimates, the range (distance) between the nodes is calculated.

However, due to resource allocations procedures for sidelink the order of SL-PRS transmissions is not guaranteed. The problem to be solved is how the receive to transmit time is calculated, and what is the detailed procedure for multi-RTT when the order is not guaranteed.

SL-PRS may require power control to limit interference and power consumption. One way to control power is where the receive UE estimates the pathloss between transmit and receiver nodes and then the transmit UE adjusts power accordingly. The received SL-PRS RSRP can be measured, however the transmit power value is necessary to estimate pathloss. There are embodiments that provide some new details on open loop power control.

As described above, the SL-PRS and the exchange of the positioning information and measurement reports require SL resources. To achieve a certain accuracy for positioning, sufficient bandwidth for SL-PRS should be allocated, particularly for timing-based positioning techniques. Therefore, SL positioning could be an on demand or per need-based process; otherwise, the resource pool would be overwhelmed by unnecessary transmission of reference signals and information exchange, increasing the system load and incurring a large number of resource collisions.

Also as described above, in Rel-17, sidelink inter-UE coordination is specified to reduce potential resource conflicts. In coordination Scheme 1, a UE (UE-A) provides the coordination information, e.g., preferred resource set or non-preferred resource set, to help the other UE (UE-B) select appropriate resources for UE-B's transmissions. The coordination can be triggered with an explicit request from UE-B or when a certain condition is met at UE-A.

This disclosure provides the design of sidelink positioning slot format, resource selection, and SL-PRS transmission.

As described in above, six positioning methods were adopted for NR RAT dependent positioning solutions, namely, DL-TDOA, DL-AOD, UL-TDOA, UL-AOA, multi-RTT, and E-CID. For sidelink, timing-based techniques can still be applied. Since there is no DL or UL, this sidelink technique can be generalized as SL-TDOA. However, as illustrated in FIG. 3 and above, the position of the target UE can be requested and estimated at either target UE or anchor UEs. New procedures are desired as the information exchange and positioning signal are on different directions.

Multi-RTT is also an efficient positioning technique to consider for sidelink. Since multi-RTT based positioning does not need synchronization, multi-RTT based position can facilitate sidelink positioning given that synchronization is not required among the anchor UEs.

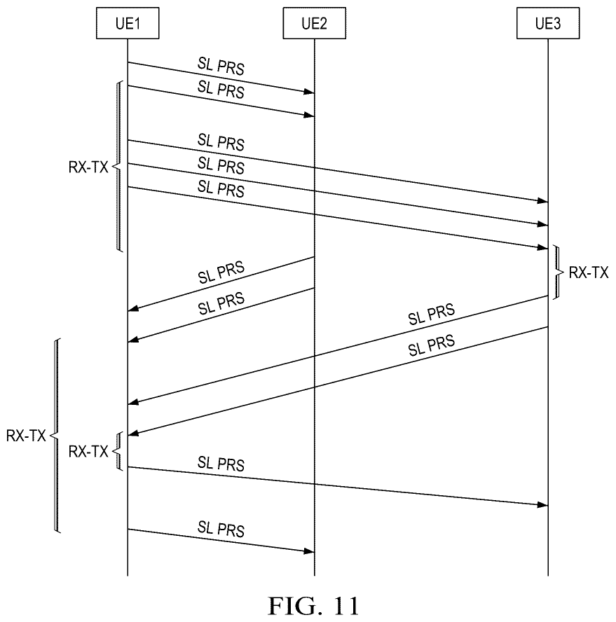

FIG. 9 illustrates the schematic diagram of sidelink ranging with a pair of UEs, where one UE 902 (the requesting UE or ranging source UE) wants to estimate its distance to another UE 904 (the responding UE or ranging remote UE). For RTT-based ranging, both UEs send a sidelink reference signal to each other sequentially. The reference signaling for SL ranging or positioning measurements is generally denoted as SL positioning reference signals (SL Pos-RS or SL PRS). Each UE records the timestamp of its transmission and measures the timing (to obtain the time stamp) of receiving the SL PRS from the other UE. Rx-Tx timing difference can be calculated based on the two timestamps measured at each UE. If the Rx-Tx timing difference at both UEs are known, the round-trip time (RTT) is then derived and the distance between two UEs can be estimated. The RTT based technique requires bi-directional transmissions of the PRSs between two UEs, as well as the transmission of the measurement of Rx-Tx time difference from one UE to the other UE, in particular, from responding UE to the requesting UE. Both types of transmissions require SL resource allocations. Note that since there may be multiple options or types on the PRS signaling as described above, the type of PRS from the UEs can be different.

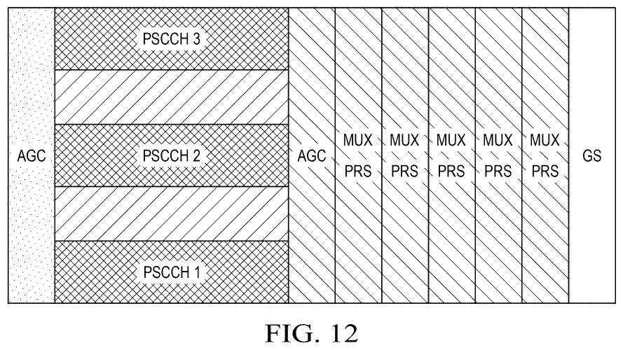

Example of the message flows are presented in FIGS. 10A-10C. FIG. 10A shows that the requesting UE sends the SL-PRS first. FIG. 10B shows that the responding UE sends the SL-PRS first. FIG. 10C shows that the requesting UE and the responding UE send SL-PRS for a certain period.

The time difference Rx-Tx is measured as the time duration between a received SL-PRS and a transmitted time of SL-PRS, this Rx-Tx measure is provided to requester to estimate the time of flight (ToF). As shown in FIGS. 10A-10C:

The requesting UE first sends the SL-PRS signal at t₁.

The responding UE receives the SL-PRS at t₂ and transmits the responding signal, e.g., Pos-RS, at t₃.

The requesting UE receives the signal from responding UE at t₄.

After t4 the responding UE then sends Rx-Tx timing (t₃−t₂) measurement report to the requesting UE.

The Rx-Tx measurement at the responding UE is the measurement of t₃−t₂. The Rx-Tx measurement at the requesting UE is the measurement of t₄−t₁. The ranging or the distance between requesting UE and responding UE is then calculated at

$${D}_{1 , 2} = c \cdot \frac{( {t}_{4} - {t}_{1} ) - ( {t}_{3} - {t}_{2} )}{2} ,$$

where c is the speed of light.

If following the fine time measurement (FTM) protocol in the IEEE 802.11 specification, the values of timestamps t₂ and t₃ are reported to the requesting UE. In multi-RTT for NR positioning, the Rx-Tx measurement t₃−t₂ is reported to the LMF.

One technical issue that can occur is when the reporting UE changes its synchronization source. In this case the slot alignment needs to be changed to be in sync with the new source of synchronization. The existing specs in TS 38.215 define the Rx-Tx in relationship with the closest subframe from the received SL-PRS and the closest transmit frame with respect to transmit subframe.

In order to compensate the additional errors introduced by the change in the synchronization source, this disclosure provides that together with the Rx-Tx time difference the UE reports a time adjustment (TA), which is defined as the difference between the new subframe timing and the old subframe timing when a change in the synchronization source occurs. If such a change does not occur the TA can still be reported but its value is zero. The reporting may be sent to the requesting UE or to a location management function (LMF) server.

In a different embodiment, TA may contain other sources of clock errors such as the clock drift, especially when the Rx-Tx is having larger values (i.e., when the clock drift has a least a minimum value between receive and transmit time).

In a different embodiment, the reported Rx-Tx time difference value may be adjusted with the corresponding time drift.

Yet in a different embodiment, an indication of synchronization source (1 bit) instead of TA may be provided, which may be used by the requesting UE to reinitiate procedure for instance and discard the results.

It is worth mentioning that the receive time could be based on the time of the first received path of the received SL-PRS.

One technical issue that can occur is whether the response of SL-PRS is coming too late because some resource selection issues or is not received due interference. The failure to receive SL-PRS due to interference could be solved by using multiple repetitions or increasing power progressively between repetitions. However, if the resources are not available, a maximum timer value may be used.

The timer (Timer 1) can be started by the initiator of the RTT procedure after its first transmission of an SL-PRS, or in case of double RTT as shown in FIG. 10C, both participants can start their own timers (T1 and T2).

In the simple RTT case, if the timer expires and no SL-PRS is received, a new RTT may be reinitiated by the requesting UE.

In the double RTT case, if the first SL-PRS from responding UE is not received before the T1 expiration, the double RTT may be reinitiated by the requesting UE. Responding UE also may have its own timer T2, which is triggered when by its transmission of SL-PRS. If the responding UE does not receive a SL-PRS from the requesting UE before the T2 expiration, the responding UE may repeat its transmission and reset its timer T1=0. The requesting UE may also monitor the end-to-end time for the RTT procedure and repeat one step or repeat the procedure from the beginning. For instance, for double RTT, if the requesting UE does not receive the second SL-PRS from the responding UE, it may just repeat its transmission of the SL-PRS for the second step of the dual RTT procedure.

As illustrated in FIG. 8, this disclosure considers a sidelink positioning system including multiple location reference UEs (e.g., the anchor UEs and a target UE). Sidelink positioning is to obtain the position of the target UE based on the location information of the anchor UEs through the SL-PRS measurements between the target UE and anchor UEs.

For multi-RTT based positioning, the single RTT for the UE in SL ranging is extended to multiple RTT measurement for all pairs of an anchor UE and the target UE. With the distance between the target UE to each anchor UE, together with location information of each anchor UEs, the location of the target UE can then be estimated.

Same as the RTT base ranging, as shown in FIG. 9, the multi-RTT SL positioning requires bidirectional SL-PRS transmissions (i.e., the SL-PRS transmissions from an anchor UE to the target UE and from the target UE). For the SL-PRS from anchor UEs to the target UE, separate transmissions are needed. For the SL-PRS from the target UE to the anchor UEs, the SL-PRS may be combined as one groupcast or broadcast transmission.

Unlike NR Uu link, sidelink transmissions are opportunistic and multiple transceiver links co-exist in the same resource pool. As described above, to avoid resource allocation conflicts between different UE-to-UE links, which causes interference, sidelink transmissions are based on resource reservations either through gNB with centralized planning under gNB's coverage or through UE sensing for mode 2 operation. Transmissions of SL reference signal for positioning purposes may also need a resource reservation. Another issue for SL positioning is that anchor UEs may move or may be deployed dynamically, implying that the locations of anchor UEs may change frequently. Therefore, the anchor UEs may need to update their locations to the target UEs. Also, depending on where the position of the target UE is estimated, exchange of the Rx-Tx measurements among the anchor UEs and target UE is needed. These transmissions also require resource allocations.

To achieve a certain accuracy for positioning, sufficient bandwidth for SL-PRS should be allocated, particularly for timing-based positioning techniques, which requires a large number of resources in a slot, which is more severe for multi-RTT based positioning as it needs the SL-PRS transmissions from two sides. To avoid by overwhelmed unnecessary SL-PRS transmissions in a SL resource pool, efficient protocol and resource allocation are desired.

Next, this disclosure first considers the design for RTT based ranging and then extend it to multi-RTT based SL positioning. Before describing the detailed design, the alternative terms for the UEs in SL ranging and positioning are provided below.

For SL ranging, this disclosure can use the following alternative terms:
UE request for ranging to a remote UE: the requesting UE, the (ranging) source UE, ranging initiating UE,
the remote UE responding to the request: the responding UE, the remote UE, the target UE.

For SL positioning, as aforementioned, a UE who provides the location reference is termed as anchor UE and the UE whose location is to be estimated (either at the UE itself or at an anchor UE) is termed as the target UE. Alternatively, this disclosure can use the following terms for the two types of UEs,
UE with the location reference: anchor UE, reference UE, location reference UE, responding UE, source UE,
UE with the location to be estimated: positioning UE, target UE, (location) requesting UE, initiating UE.

Note that there may be some difference on the term of “request” or “initiating” in SL ranging and positioning. As described below, in SL ranging, the UE requesting for ranging usually initiates the ranging process and sends the request to the target (remote) UE for estimating the distance of the target UE. While in SL positioning, usually the target UE with its position to be estimated sends the request. However, in SL positioning, an anchor UE may initiate the positioning process. This anchor UE, termed as the serving anchor UE, may send an explicit request to the target UE and request the transmission of SL Pos-RS. Meanwhile, the anchor UE may need to send different requests to other anchor UEs (coordinate anchor UEs) to coordinate measurements. In such a scenario, the definition of “request”/“initiating” is consistent with that in SL ranging. However, in this scenario, this disclosure still refers the anchor UE as serving anchor UE without changing it to “request” or “initiating” UE, but not refer the target UE as requesting UE or initiating UE to avoid the confusion.

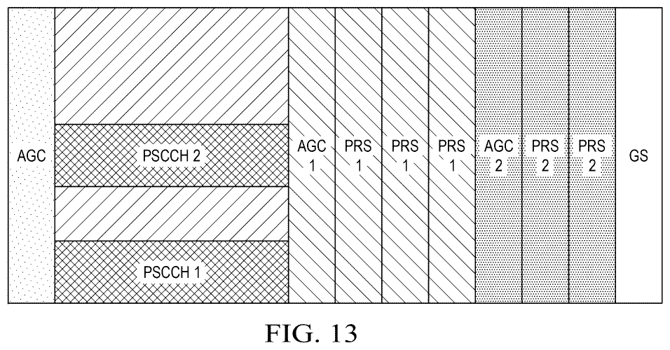

Due to resource selection constraints, in a multi-RTT procedure, it may not be possible to always have successive transmission of SL-PRS from the requesting UE and responding UEs as presented in FIGS. 10A-10C. When it happens, this disclosure refers this scenario “out-of-order” multi RTT. Moreover, it may be beneficial that some of the SL-PRS transmissions are multicast to a group of UEs, so the out-of-order situation occurs as a way to increase SL-PRS channel capacity. FIG. 11 shows an example of out of order multi-RTT.

As shown in FIG. 11, for reliability purpose, sometimes the SL-PRS may be repeated. In the case of out-of-order scenario the Rx-Tx time difference can be redefined.

This disclosure provides that the Rx-Tx to be defined as the time duration (which does not exceed a maximum duration time) between the first path of the last SL-PRS received and the time of the next SL-PRS transmission to the same UE (or group of UEs). In this way, the most recent SL-PRS is considered, and the chances of changing synchronization sources are minimized.

To achieve a higher capacity of SL-PRS and a lower latency of measurements, it is desirable if multiple UE transmissions of SL-PRS are multiplexed in the same slot. There are various ways to achieve this goal.

Using FDM (frequency division multiplexing), different SL-PRS transmissions can occupy the same symbol. A usual mode to do this is via comb frequency structure, where a transmission occupies every other M resource, and several UEs may be interlaced in frequency domain. Using TDM (time division multiplexing), several UEs may occupy different symbols in the same slot.

An SL-PRS transmission may be preceded by PSCCH and PSSCH, which carries the control information associated with the SL-PRS including decoding SCI-2 if present.

In another embodiment, the SL-PRS can be transmitted without PSCCH in the same slot. Such scenario may occur for semi-persistent or periodic SL-PRS transmissions.

A semi-persistent SL-PRS transmission is a periodic transmission that can be enabled or disabled by another UE or TRP via a media access control (MAC) control element (CE) or other means (L1 control, higher layers, etc.).

This disclosure provides several embodiment slot formats for SL-PRS transmission. If the multiplexing of SL PRS from different UEs in a slot is supported at least for dedicated resource pools, a technical solution to multiplex in the same slot the associated PSCCH can be achieved.

Because each legacy PSCCH can occupy just contiguous sub-channels, multiple PSCCH in the same slot could occupy different sub-channels, where each first symbol of PSCCH field is duplicated in the first symbol of the slot for AGC purposes. In addition, in PSCCH, each transmission could contain a DMRS.

A second AGC symbol, which includes duplication multiplexed SL-PRS might be used if the SL-PRS transmission power differs from the PSCCH transmission power.

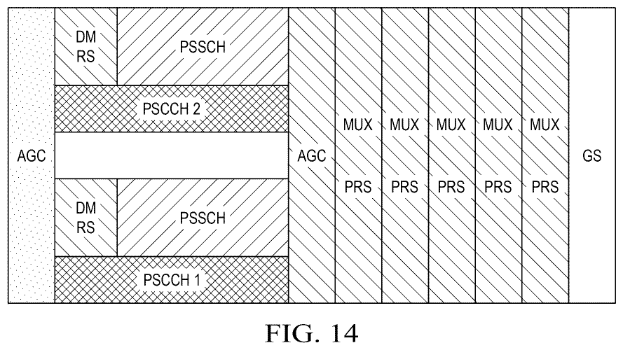

FIG. 12 shows an example FDM slot format. To avoid the using SCI-2 (PSSCH), in one embodiment, (implicit, rule based) mapping between the PSCCH and SL-PRS may be used. For instance, each PSCCH location in frequency is associated with a specific location of SL-PRS in frequency (comb size, RE offset, etc.). The relationship between PSCCH and SL-PRS may be (pre-)configured, and or specified as a table entry (codebook) or analytical relation, etc.

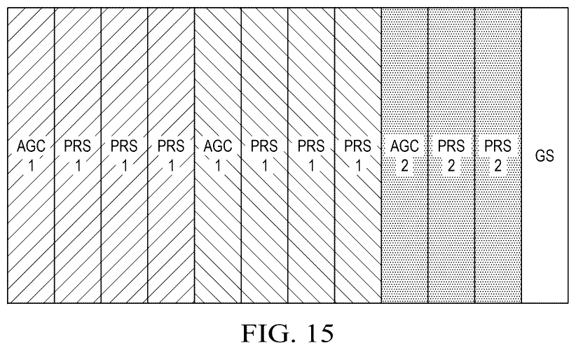

FIG. 13 shows an example TDM slot format. TDM SL-PRS can be supported in the same slot at least in the dedicated resource pools. As in the FDM case, multiple PSCCH could be multiplexed in the same slot. Because SL-PRS received from different UEs have different powers, each set of consecutive SL-PRS symbols from the same UE may be preceded by an AGC symbol.

Like in the FDM approach, a direct (implicit, rule based) mapping between the PSCCH location and SL-PRS starting symbol is shown in FIG. 13. For instance, PSCCH 1 is associated with starting symbol (let name it symbol 1) of SL-PRS 1, PSCCH 2 associated with starting symbol (symbol 2) pf SL-PRS 2, etc.

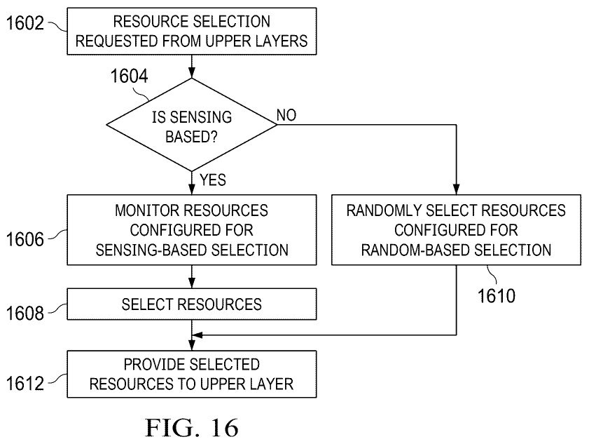

If there is not a direct relationship between the PSCCH and SL-PRS allocations, a sidelink control indication (SCI) format 2 carried by PSSCH may be added to provide additional information about SL-PRS. FIG. 14 shows such slot format.

It is noted that the above figures (e.g., FIGS. 12-14) are from a receiver UE's point of view.

When multiplexing SL-PRS from multiple UEs in the same slots, interference between SL-PRS may occur. Inter-symbol interference (ISI) may be caused due to differences in synchronization and propagation time. If such differences are shorter than the OFDM symbol cyclic prefix, the impact is negligible. For larger time differences with respect to the OFDM symbol duration, which may be the case for higher SCS, additional restrictions on resource reservation and selection may be used, for instance, leaving unoccupied one symbol between consecutive transmissions from different UEs.

Similarly, for FDM, frequency differences between SL-PRS from different UEs caused by the carrier frequency offsets (CFOs), and by the Doppler spread due to channel time-variation may lead to inter-carrier interference (ICI). To avoid ICI, an additional frequency offset between different SL-PRS transmissions may be used.

Finally, for short distance between UEs and lower frequency, it is expected that the ISI and ICI interference is relatively low due to the short propagation time with respect to the OFDM symbol duration.

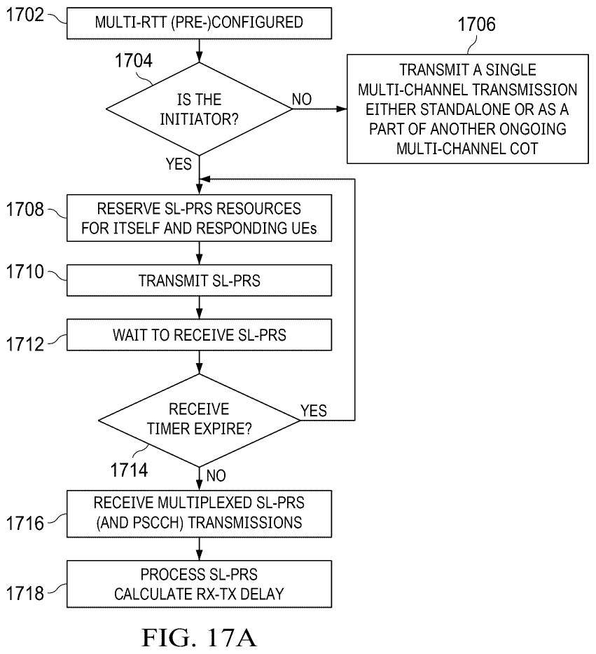

FIG. 15 shows another possible slot format, a slot which contains only SL-PRS multiplexed signals.

While no shown in FIGS. 12 and 14, the last symbol in the slot may be a guard symbol (GS) for switching between receiving and transmitting.

It was agreed in RAN1 that both sensing based and random selection-based resource selection will be supported in the same resource pool. However, several technical issues need to be solved.

One issue is that with the SL-PRS multiplexing, the resource selection may be changed accordingly. To solve this issue, in one embodiment, the monitoring may be with a finer granularity, in other words, at the level of multiplexing granularity. For instance, for TDM, the monitoring, resource selection, and reservation could be done at the symbol level. While for FDM, the resource monitoring, selection and reservation could be done at the frequency resource level including, but not limited to, comb, RE offset, or cyclic shift.

Moreover, in a different embodiment, the resource pool may accommodate both FDM and TDM multiplexing. To this end, the resource pools (at the multiplexing granularity level) may be further partitioned in resources that support TDM, FDM, or both. This partition may be (pre-)configured, or provided (in Scheme 1) via SSB, system information block (SIB), or radio resource control (RRC) configuration from gNB.

Therefore, resource selection for SL-PRS can follow this partitioning.

Similarly, for sensing based and respectively random based allocation, the resource pool may be further partitioned to allow either sensing based or random based or both with the purpose of reducing resource collisions and providing fairness to different UEs.

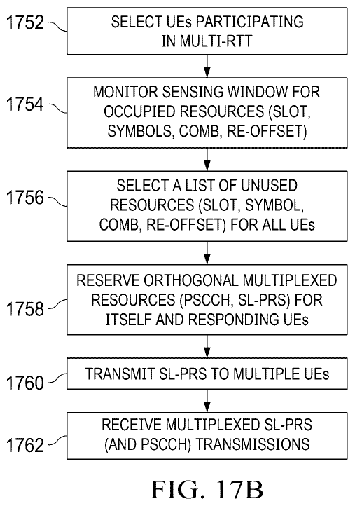

FIG. 16 shows an example flowchart of SL-PRS resource selection, according to some embodiments. At the operation 1602, a lower layer of the UE receives the resource selection from the upper layer. For example, in resource allocation mode 2, the higher layer can request the UE to determine a subset of resources from which the higher layer may select resources for PSSCH/PSCCH transmission. In this process, the higher layer provides several parameters to the lower layer such as: the resource pool, the Li priority, the remaining packet delay budget, the number of sub-channels, resource reservation interval, a set of resources for re-evaluation, and/or a set of resources for pre-emption. For the sensing based resource selection, the lower layer (PHY layer) may use these parameters to measure the received PSCCH and PSSCH during the sensing window and to send back to the L2 (upper layer) a set of candidate resources. The L2 may select the resources from the candidate set for the resource reservation. If the resource selection is not sensing based, the lower layer (L1) may just randomly select resources based on the parameters provided by the upper (L2) layer.

At the operation 1604, the lower layer of the UE determines whether the resource allocation is sensing based. If yes, at the operation 1606, the lower layer of the UE monitors resources configured for sensing-based selection. The lower layer of the UE then selects the resources at the operation 1608 based on the monitoring, and provides the selected resources to the upper layer(s) at the operation 1612. If the resource allocation is not sensing based, the lower layer of the UE randomly selects resources configured for random-based selection at the operation 1610 and provides the selected resources to the upper layer(s) at the operation 1612.

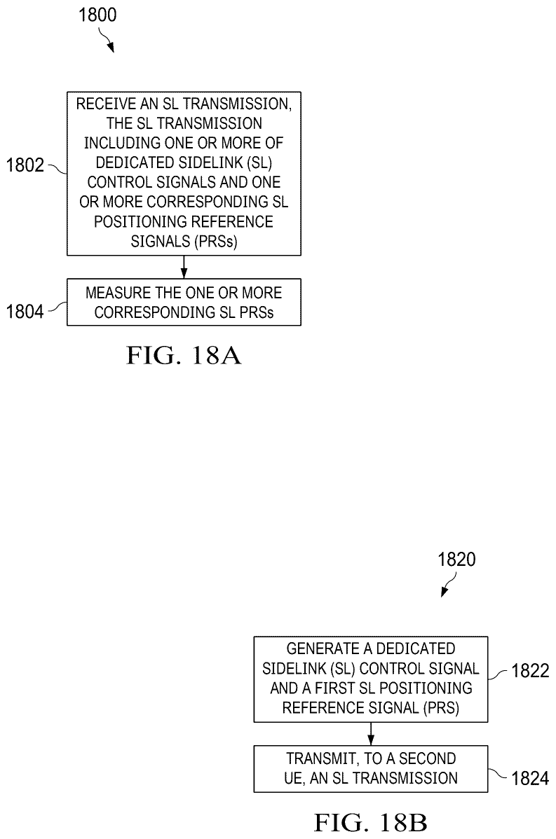

FIGS. 17A-B show the example flowcharts for multi-RTT resource allocation usage and timer expiration, according to some embodiments. FIG. 17A shows an example flow chart of a multi-RTT procedure. At the operation 1702, multi-RTT is (pre-)configured for a UE. At the operation 1704, if the UE is not the initiator, the UE transmits a single multi-channel transmission either standalone or as a part of another ongoing multi-channel channel occupancy time (COT) at the operation 1706. If the UE is the initiator, at the operation 1708, the UE reserves SL-PRS resources for itself and the responding UEs. For the multi-RTT procedure, the initiator UE first selects the necessary resources using (pre-)configured resource partitions accordingly, for instance, using sensing based or random selection-based partitions, and respectively using the partitions for TDM and FDM type of multiplexing. The requesting UE (i.e., the initiator) may select resources for itself, or for a group of participating (responding) UEs. Once the selection is done, the requesting UE can trigger the multi-RTT procedure in various ways. In one embodiment, the requesting UE transmits SL-PRS to one or multiple UEs (via multicast or broadcast) with an indication of the corresponding resources selected and types of multiplexing. In a different embodiment, the requesting UE just transmits its own SL-PRS and requests transmissions from the responding UEs, where each responding UE would further select its own resources based on the constraints related to available resources and type of multiplexing. At the operation 1710, the UE transmits an SL-PRS. At the operation 1712, the UE waits to receive the SL-PRS from the responding UE(s). At the operation 1714, the UE determines if a condition was met (e.g., whether the receive timer has expired or a preset time has arrived, or more generally whether a specific amount of time has elapsed). If yes, the flow moves to the operation 1708. Before the condition is met (e.g., before the receiver timer expiration or before the preset time), the UE receives the multiplexed SL-PRS (and the corresponding PSCCH) transmissions at the operation 1716. At the operation 1718, the UE processes the received SL-PRS and calculates the Rx-Tx delay.

In some embodiments, before the operation 1714, the initiator (requesting) UE may start its own receive timer (T1), and if the receive timer expires before receiving a SL-PRS, the requesting UE may or may not restart the procedure as described above with respect to FIG. 17A. Similarly, instead of using its own receive timer, the UE can determine that a specific amount of time has elapsed in another manner.

The Inter-UE coordination (IUC) procedure that exists in Release 17 may be enhanced to support features described in this disclosure. FIG. 17B shows an example flow chart of an IUC procedure. At the operation 1752, a requesting UE selects UEs participating in the multi-RTT. At the operation 1754, the requesting UE monitors the sensing window for occupied resources (e.g., slot, symbol, comb, RE offset). At the operation 1756, the requesting UE selects a list of unused resources (e.g., slot, symbol, comb, RE offset) for all UEs. At the operation 1758, the requesting UE reserves orthogonal multiplexed resources (for e.g., PSCCH and SL-PRS) for itself and the responding UEs. At the operation 1760, the requesting UE transmits the SL-PRS to multiple UEs. At the operation 1762, the requesting UE receives multiplexed SL-PRS (and the corresponding PSCCH) transmissions.

In one embodiment for the IUC procedure, UE1 (e.g., the requesting UE) provides to UE2 (e.g., the responding UE) information about the preferred resources for SL-PRS transmission when UE2 selects from these preferred resources. The preferred resources can be resources in time, frequency, cyclic shift in addition to those already specified in Rel 17. Similarly, for non-preferred set of resources, additional level of granularity (e.g., symbol, comb, RE offset) can be provided.

In an embodiment, the congestion control may be applied, where the metrics of channel busy ratio (CBR) and channel occupancy ratio (CR) defined in TS 38.215, have a new granularity. In other words, these metrics may be defined for each of the partition of resources defined above, and may be used to decide whether there are necessary resources available in those partitions for that type of resource selection.

SL-PRS can be power controlled to avoid interference. An open loop power control mechanism may be used where the transmit power compensates for the pathloss between transmit (UE1) and receiver (UE2). To estimate pathloss, the receiver may need a reference power from the transmitter. Such reference power may be obtained from a known received signal such as SSB, CSI-RS, or a previous SL-PRS. For instance, UE1 can control the transmit power of SL-PRS transmitted to UE2. For this purpose, for instance, in double RTT application, where UE1 firstly receives a SL-PRS from UE2 and then itself has to transmit a SL-PRS to UE2, UE1 can measure received power of signals from UE2 (for instance SL-PRS RSRP) and calculate the pathloss. To do this, UE1 may know what the transmit power of SL-PRS from UE2 was to estimate the pathloss and adjust its own SL-PRS power. This can be accomplished, for instance, if UE2 uses SCI2 together with SL-PRS transmission to inform UE1 about its own transmit power. Then, based on this information, UE1 can adjust its own SL-PRS transmit power to UE2. In a different embodiment, the transmit power may be known via (pre-)configuration or MAC CE, RRC, etc.

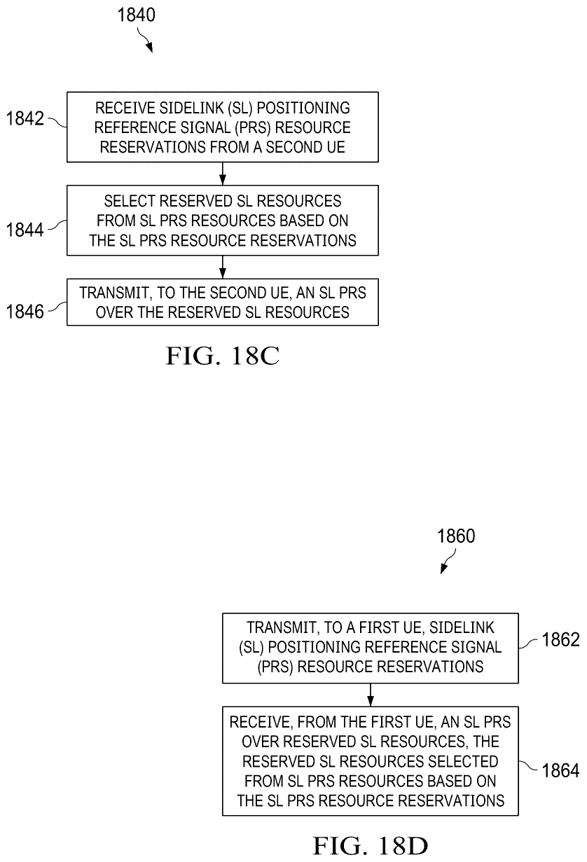

FIG. 18A shows a flow chart of a method 1800 performed by a second UE, according to some embodiments. The second UE may include computer-readable code or instructions executing on one or more processors of the second UE. Coding of the software for carrying out or performing the method 1800 is well within the scope of a person of ordinary skill in the art having regard to the present disclosure. The method 1800 may include additional or fewer operations than those shown and described and may be carried out or performed in a different order. Computer-readable code or instructions of the software executable by the one or more processors may be stored on a non-transitory computer-readable medium, such as for example, the memory of the second UE. In some embodiments, the method 1800 may be performed by one or more of units or modules (e.g., an integrated circuit) of the second UE, such as field programmable gate arrays (FPGAs) or application-specific integrated circuits (ASICs).

The method 1800 starts at the operation 1802, where the second UE receives an SL transmission. The SL transmission includes one or more of dedicated sidelink (SL) control signals and one or more corresponding SL positioning reference signals (PRSs) over resources in a dedicated resource pool. The dedicated resource pool is dedicated for physical sidelink control channel (PSCCH) and SL PRS transmissions. At the operation 1804, the second UE measures the one or more corresponding SL PRSs.

In some embodiments, the second UE may receive the SL transmission in a slot.

In some embodiments, each pair of a dedicated SL control signal and a corresponding SL PRS from the one or more dedicated SL control signals and the one or more corresponding SL PRSs may be sent by a different corresponding transmitting UE.

In some embodiments, the slot may include one or more PSCCHs mapped to the one or more corresponding PRSs. Resource allocation of the one or more PSCCHs may be associated with resource allocation of the one or more corresponding SL PRSs. For example, resource allocation of the one or more PSCCHs may be dependent on resource allocation of the one or more corresponding SL PRSs. Or, resource allocation of the one or more corresponding SL PRSs may be dependent on resource allocation of the one or more PSCCHs.

In some embodiments, mappings between the one or more PSCCHs and the one or more corresponding SL PRSs may be pre-configured or configured.

In some embodiments, the second UE may determine a first SL PRS resource for receiving a first SL PRS from a first UE based on the mappings and a first PSCCH resource for receiving a first PSCCH of the one or more PSCCHs from the first UE.

In some embodiments, the one or more dedicated SL control signals may include a first SL control signal from a first UE. The first SL control signal may include a trigger indication. The second UE may transmit a second SL PRS to the first UE based on the trigger indication.

In some embodiments, the second UE may report a measurement report. The measurement report indicating a relative time difference based on the measuring the one or more corresponding SL PRSs and a synchronization source type.

In some embodiments, each of the one or more corresponding SL PRSs may occupy respective continuous symbols, and the respective continuous symbols may be preceded by a corresponding automatic generation control (AGC) symbol.

In some embodiments, a received power of an SL signal may be based on a transmission power of a previous SL PRS transmitted by the second UE to the first UE.

FIG. 18B shows a flow chart of a method 1820 performed by a first UE, according to some embodiments. The first UE may include computer-readable code or instructions executing on one or more processors of the first UE. Coding of the software for carrying out or performing the method 1820 is well within the scope of a person of ordinary skill in the art having regard to the present disclosure. The method 1820 may include additional or fewer operations than those shown and described and may be carried out or performed in a different order. Computer-readable code or instructions of the software executable by the one or more processors may be stored on a non-transitory computer-readable medium, such as for example, the memory of the first UE. In some embodiments, the method 1820 may be performed by one or more of units or modules (e.g., an integrated circuit) of the first UE, such as field programmable gate arrays (FPGAs) or application-specific integrated circuits (ASICs).

The method 1820 begins at the operation 1822, where the first UE generates a dedicated sidelink (SL) control signal and a first SL positioning reference signal (PRS). At the operation 1824, the first UE transmits, to a second UE, an SL transmission. The SL transmission is over resources in a dedicated resource pool. The dedicated resource pool is dedicated for physical sidelink control channel (PSCCH) and SL PRS transmissions. The SL transmission includes the dedicated SL control signal and the first SL PRS.

In some embodiments, the first UE may transmit the SL transmission in a slot.

In some embodiments, the resources may include a first SL PRS resource for transmitting the first SL PRS and a first PSCCH resource for transmitting the dedicated SL control signal. A mapping between the first SL PRS resource and the first PSCCH resource may be pre-configured or configured.

In some embodiments, the first SL PRS may occupy continuous symbols. The continuous symbols in the SL transmission may be preceded by an automatic generation control (AGC) symbol in the SL transmission.

In some embodiments, the dedicated SL control signal may include a trigger indication for triggering the second UE to send a second SL PRS to the first UE.

In some embodiments, the first UE may transmit to the second UE an SL signal. A transmission power of the SL signal may be based on a received power of a previous SL PRS received by the first UE from the second UE.

In some embodiments, the first UE may receive a measurement report. The measurement report may indicate a relative time difference based on the measuring and a synchronization source type. The first UE may perform sidelink positioning based on the relative time difference indicated by the measurement report.

FIG. 18C shows a flow chart of a method 1840 performed by a first UE, according to some embodiments. The first UE may include computer-readable code or instructions executing on one or more processors of the first UE. Coding of the software for carrying out or performing the method 1840 is well within the scope of a person of ordinary skill in the art having regard to the present disclosure. The method 1840 may include additional or fewer operations than those shown and described and may be carried out or performed in a different order. Computer-readable code or instructions of the software executable by the one or more processors may be stored on a non-transitory computer-readable medium, such as for example, the memory of the first UE. In some embodiments, the method 1840 may be performed by one or more of units or modules (e.g., an integrated circuit) of the first UE, such as field programmable gate arrays (FPGAs) or application-specific integrated circuits (ASICs).

The method 1840 starts at the operation 1842, where the first UE receives sidelink (SL) positioning reference signal (PRS) resource reservations from a second UE. At the operation 1844, the first UE selects reserved SL resources from SL PRS resources based on the SL PRS resource reservations. At the operation 1846, the first UE transmits, to the second UE, an SL PRS over the reserved SL resources.

In some embodiments, the reserved SL resources may indicate at least one of a sequence of symbols in a slot or a frequency distribution of the SL PRS. The frequency distribution of the SL PRS may include a comb distribution of SL PRS.

In some embodiments, the reserved SL resources may be selected based on a congestion control metric. The congestion control metric may be based on a ratio of the SL PRS resources over available resources.

FIG. 18D shows a flow chart of a method 1860 performed by a second UE, according to some embodiments. The second UE may include computer-readable code or instructions executing on one or more processors of the second UE. Coding of the software for carrying out or performing the method 1860 is well within the scope of a person of ordinary skill in the art having regard to the present disclosure. The method 1860 may include additional or fewer operations than those shown and described and may be carried out or performed in a different order. Computer-readable code or instructions of the software executable by the one or more processors may be stored on a non-transitory computer-readable medium, such as for example, the memory of the second UE. In some embodiments, the method 1860 may be performed by one or more of units or modules (e.g., an integrated circuit) of the second UE, such as field programmable gate arrays (FPGAs) or application-specific integrated circuits (ASICs).

The method 1860 starts at the operation 1862, where the second UE transmits, to a first UE, sidelink (SL) positioning reference signal (PRS) resource reservations. At the operation 1864, the second UE receives, from the first UE, an SL PRS over reserved SL resources. The reserved SL resources from SL PRS resources are indicated by the SL PRS resource reservations.

In some embodiments, the reserved SL resources may indicate at least one of a sequence of symbols in a slot or a frequency distribution of the SL PRS. The frequency distribution of the SL PRS may include a comb distribution of SL PRS.

In some embodiments, the reserved SL resources may be selected based on a congestion control metric. The congestion control metric may be based on a ratio of the SL PRS resources over available resources.

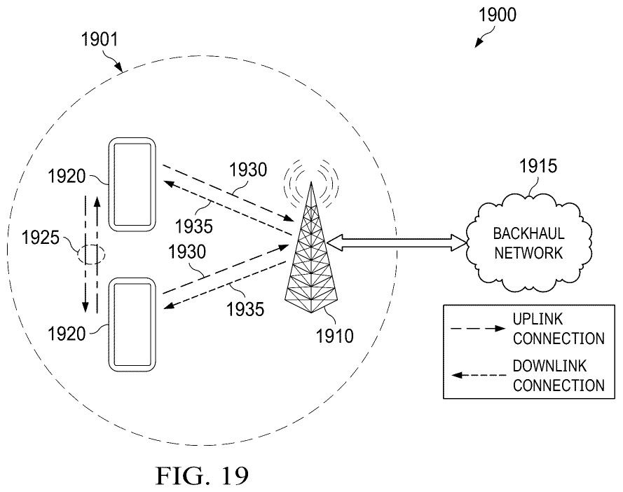

FIG. 19 illustrates an example communications system 1900. Communications system 1900 includes an access node 1910 serving user equipments (UEs) with coverage 1901, such as UEs 1920. In a first operating mode, communications to and from a UE passes through access node 1910 with a coverage area 1901. The access node 1910 is connected to a backhaul network 1915 for connecting to the internet, operations and management, and so forth. In a second operating mode, communications to and from a UE do not pass through access node 1910, however, access node 1910 typically allocates resources used by the UE to communicate when specific conditions are met. Communications between a pair of UEs 1920 can use a sidelink connection (shown as two separate one-way connections 1925). In FIG. 19, the sideline communication is occurring between two UEs operating inside of coverage area 1901. However, sidelink communications, in general, can occur when UEs 1920 are both outside coverage area 1901, both inside coverage area 1901, or one inside and the other outside coverage area 1901. Communication between a UE and access node pair occur over uni-directional communication links, where the communication links between the UE and the access node are referred to as uplinks 1930, and the communication links between the access node and UE is referred to as downlinks 1935.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

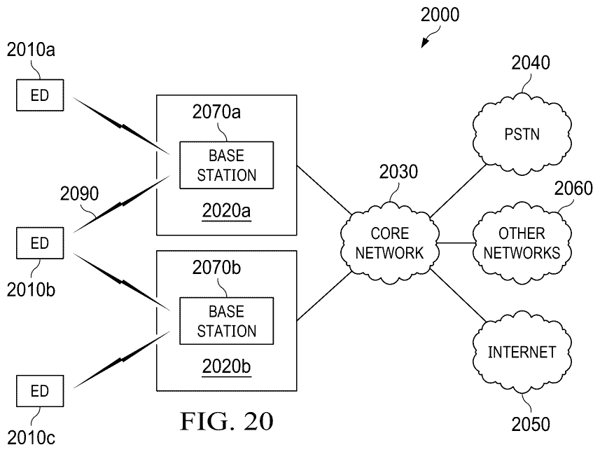

FIG. 20 illustrates an example communication system 2000. In general, the system 2000 enables multiple wireless or wired users to transmit and receive data and other content. The system 2000 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 2000 includes electronic devices (ED) 2010a-2010c, radio access networks (RANs) 2020a-2020b, a core network 2030, a public switched telephone network (PSTN) 2040, the Internet 2050, and other networks 2060. While certain numbers of these components or elements are shown in FIG. 20, any number of these components or elements may be included in the system 2000.

The EDs 2010a-2010c are configured to operate or communicate in the system 2000. For example, the EDs 2010a-2010c are configured to transmit or receive via wireless or wired communication channels. Each ED 2010a-2010c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 2020a-2020b here include base stations 2070a-2070b, respectively. Each base station 2070a-2070b is configured to wirelessly interface with one or more of the EDs 2010a-2010c to enable access to the core network 2030, the PSTN 2040, the Internet 2050, or the other networks 2060. For example, the base stations 2070a-2070b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 2010a-2010c are configured to interface and communicate with the Internet 2050 and may access the core network 2030, the PSTN 2040, or the other networks 2060.

In the embodiment shown in FIG. 20, the base station 2070a forms part of the RAN 2020a, which may include other base stations, elements, or devices. Also, the base station 2070b forms part of the RAN 2020b, which may include other base stations, elements, or devices. Each base station 2070a-2070b operates to transmit or receive wireless signals within a particular geographic region or area, sometimes referred to as a “cell.” In some embodiments, multiple-input multiple-output (MIMO) technology may be employed having multiple transceivers for each cell.

The base stations 2070a-2070b communicate with one or more of the EDs 2010a-2010c over one or more air interfaces 2090 using wireless communication links. The air interfaces 2090 may utilize any suitable radio access technology.

It is contemplated that the system 2000 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 2020a-2020b are in communication with the core network 2030 to provide the EDs 2010a-2010c with voice, data, application, Voice over Internet Protocol (VOIP), or other services. Understandably, the RANs 2020a-2020b or the core network 2030 may be in direct or indirect communication with one or more other RANs (not shown). The core network 2030 may also serve as a gateway access for other networks (such as the PSTN 2040, the Internet 2050, and the other networks 2060). In addition, some or all of the EDs 2010a-2010c may include functionality for communicating with different wireless networks over different wireless links using different wireless technologies or protocols. Instead of wireless communication (or in addition thereto), the EDs may communicate via wired communication channels to a service provider or switch (not shown), and to the Internet 2050.

Although FIG. 20 illustrates one example of a communication system, various changes may be made to FIG. 20. For example, the communication system 2000 could include any number of EDs, base stations, networks, or other components in any suitable configuration.

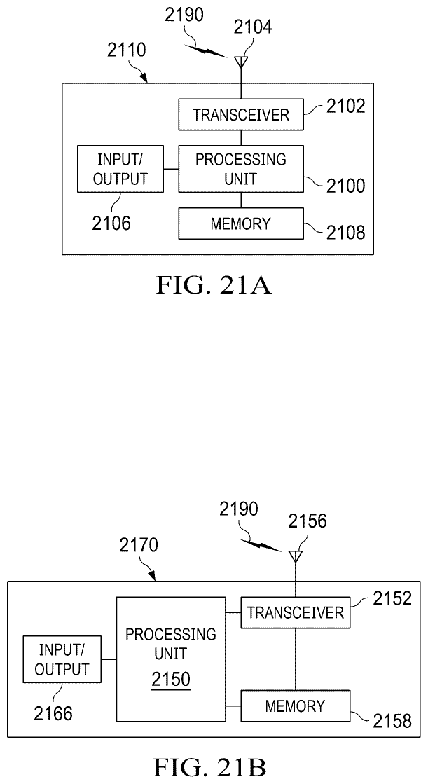

FIGS. 21A and 21B illustrate example devices that may implement the methods and teachings according to this disclosure. In particular, FIG. 21A illustrates an example ED 2110, and FIG. 21B illustrates an example base station 2170. These components could be used in the system 2000 or in any other suitable system.

As shown in FIG. 21A, the ED 2110 includes at least one processing unit 2100. The processing unit 2100 implements various processing operations of the ED 2110. For example, the processing unit 2100 could perform signal coding, data processing, power control, input/output processing, or any other functionality enabling the ED 2110 to operate in the system 2000. The processing unit 2100 also supports the methods and teachings described in more detail above. Each processing unit 2100 includes any suitable processing or computing device configured to perform one or more operations. Each processing unit 2100 could, for example, include a microprocessor, microcontroller, digital signal processor, field programmable gate array, or application specific integrated circuit.

The ED 2110 also includes at least one transceiver 2102. The transceiver 2102 is configured to modulate data or other content for transmission by at least one antenna or NIC (Network Interface Controller) 2104. The transceiver 2102 is also configured to demodulate data or other content received by the at least one antenna 2104. Each transceiver 2102 includes any suitable structure for generating signals for wireless or wired transmission or processing signals received wirelessly or by wire. Each antenna 2104 includes any suitable structure for transmitting or receiving wireless or wired signals. One or multiple transceivers 2102 could be used in the ED 2110, and one or multiple antennas 2104 could be used in the ED 2110. Although shown as a single functional unit, a transceiver 2102 could also be implemented using at least one transmitter and at least one separate receiver.

The ED 2110 further includes one or more input/output devices 2106 or interfaces (such as a wired interface to the Internet 2050). The input/output devices 2106 facilitate interaction with a user or other devices (network communications) in the network. Each input/output device 2106 includes any suitable structure for providing information to or receiving information from a user, such as a speaker, microphone, keypad, keyboard, display, or touch screen, including network interface communications.

In addition, the ED 2110 includes at least one memory 2108. The memory 2108 stores instructions and data used, generated, or collected by the ED 2110. For example, the memory 2108 could store software or firmware instructions executed by the processing unit(s) 2100 and data used to reduce or eliminate interference in incoming signals. Each memory 2108 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 21B, the base station 2170 includes at least one processing unit 2150, at least one transceiver 2152, which includes functionality for a transmitter and a receiver, one or more antennas 2156, at least one memory 2158, and one or more input/output devices or interfaces 2166. A scheduler, which would be understood by one skilled in the art, is coupled to the processing unit 2150. The scheduler could be included within or operated separately from the base station 2170. The processing unit 2150 implements various processing operations of the base station 2170, such as signal coding, data processing, power control, input/output processing, or any other functionality. The processing unit 2150 can also support the methods and teachings described in more detail above. Each processing unit 2150 includes any suitable processing or computing device configured to perform one or more operations. Each processing unit 2150 could, for example, include a microprocessor, microcontroller, digital signal processor, field programmable gate array, or application specific integrated circuit.

Each transceiver 2152 includes any suitable structure for generating signals for wireless or wired transmission to one or more EDs or other devices. Each transceiver 2152 further includes any suitable structure for processing signals received wirelessly or by wire from one or more EDs or other devices. Although shown combined as a transceiver 2152, a transmitter and a receiver could be separate components. Each antenna 2156 includes any suitable structure for transmitting or receiving wireless or wired signals. While a common antenna 2156 is shown here as being coupled to the transceiver 2152, one or more antennas 2156 could be coupled to the transceiver(s) 2152, allowing separate antennas 2156 to be coupled to the transmitter and the receiver if equipped as separate components. Each memory 2158 includes any suitable volatile or non-volatile storage and retrieval device(s). Each input/output device 2166 facilitates interaction with a user or other devices (network communications) in the network. Each input/output device 2166 includes any suitable structure for providing information to or receiving/providing information from a user, including network interface communications.

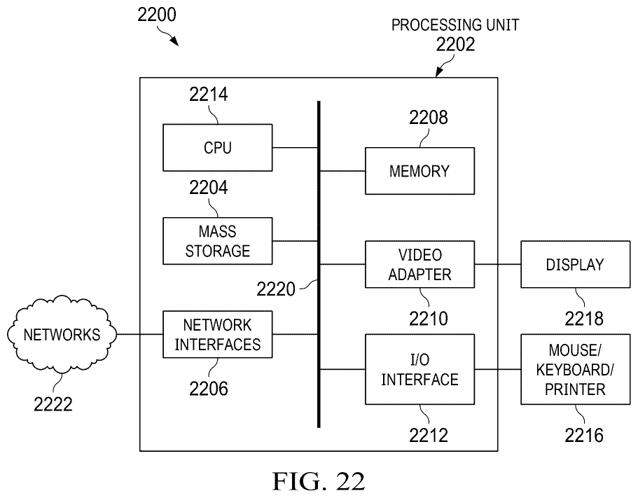

FIG. 22 is a block diagram of a computing system 2200 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 2200 includes a processing unit 2202. The processing unit includes a central processing unit (CPU) 2214, memory 2208, and may further include a mass storage device 2204, a video adapter 2210, and an I/O interface 2212 connected to a bus 2220.

The bus 2220 may be one or more of any type of several bus architectures including a memory bus or memory controller, a peripheral bus, or a video bus. The CPU 2214 may comprise any type of electronic data processor. The memory 2208 may comprise any type of non-transitory system memory such as static random access memory (SRAM), dynamic random access memory (DRAM), synchronous DRAM (SDRAM), read-only memory (ROM), or a combination thereof. In an embodiment, the memory 2208 may include ROM for use at boot-up, and DRAM for program and data storage for use while executing programs.

The mass storage 2204 may comprise any type of non-transitory storage device configured to store data, programs, and other information and to make the data, programs, and other information accessible via the bus 2220. The mass storage 2204 may comprise, for example, one or more of a solid state drive, hard disk drive, a magnetic disk drive, or an optical disk drive.

The video adapter 2210 and the I/O interface 2212 provide interfaces to couple external input and output devices to the processing unit 2202. As illustrated, examples of input and output devices include a display 2218 coupled to the video adapter 2210 and a mouse, keyboard, or printer 2216 coupled to the I/O interface 2212. Other devices may be coupled to the processing unit 2202, and additional or fewer interface cards may be utilized. For example, a serial interface such as Universal Serial Bus (USB) (not shown) may be used to provide an interface for an external device.

The processing unit 2202 also includes one or more network interfaces 2206, which may comprise wired links, such as an Ethernet cable, or wireless links to access nodes or different networks. The network interfaces 2206 allow the processing unit 2202 to communicate with remote units via the networks. For example, the network interfaces 2206 may provide wireless communication via one or more transmitters/transmit antennas and one or more receivers/receive antennas. In an embodiment, the processing unit 2202 is coupled to a local-area network 2222 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method, comprising:
receiving, by a user equipment (UE), a sidelink (SL) transmission, the SL transmission including one or more of dedicated SL control signals and one or more corresponding SL positioning reference signals (PRSs) over resources in a dedicated resource pool, wherein the dedicated resource pool is dedicated for physical sidelink control channel (PSCCH) and SL PRS transmissions; and
measuring, by the UE, the one or more corresponding SL PRSs.

2. The method of claim 1, wherein each pair of a dedicated SL control signal and a corresponding SL PRS from the one or more dedicated SL control signals and the one or more corresponding SL PRSs is sent by a different corresponding transmitting UE.

3. The method of claim 1, wherein the SL transmission is received in a slot that comprises one or more PSCCHs mapped to the one or more corresponding PRSs, wherein resource allocation of the one or more PSCCHs is associated with resource allocation of the one or more corresponding SL PRSs.

4. The method of claim 3, further comprising:
determining, by the UE, a first SL PRS resource for receiving a first SL PRS from a first UE based on mappings between the one or more PSCCHs and the one or more corresponding SL PRSs and based on a first PSCCH resource for receiving a first PSCCH of the one or more PSCCHs from the first UE.

5. The method of claim 1, wherein the one or more dedicated SL control signals includes a first SL control signal from a first UE, and wherein the first SL control signal includes a trigger indication, the method further comprising:
transmitting, by the UE, a second SL PRS to the first UE based on the trigger indication.

6. The method of claim 1, further comprising:
reporting, by the UE, a measurement report, the measurement report indicating a relative time difference based on the measuring and a synchronization source type.

7. The method of claim 1, wherein each of the one or more corresponding SL PRSs occupies respective continuous symbols, the respective continuous symbols preceded by a corresponding automatic generation control (AGC) symbol.

8. The method of claim 1, wherein a received power of an SL signal is based on a transmission power of a previous SL PRS transmitted by the UE to a first UE.

9. The method of claim 1, wherein the one or more corresponding SL PRSs comprise a comb SL PRS transmission on every multiple resource elements (Res) in the frequency domain.

10. A method, comprising:
generating, by a first user equipment (UE), a dedicated sidelink (SL) control signal and a first SL positioning reference signal (PRS); and
transmitting, by the first UE to a second UE, an SL transmission, the SL transmission over resources in a dedicated resource pool, wherein the dedicated resource pool is dedicated for physical sidelink control channel (PSCCH) and SL PRS transmissions, the SL transmission including the dedicated SL control signal and the first SL PRS.

11. The method of claim 10, the resources including a first SL PRS resource for transmitting the first SL PRS and a first PSCCH resource for transmitting the dedicated SL control signal, a mapping between the first SL PRS resource and the first PSCCH resource being pre-configured or configured.

12. The method of claim 10, the first SL PRS occupies continuous symbols in the SL transmission, the continuous symbols preceded by an automatic generation control (AGC) symbol in the SL transmission.

13. The method of claim 10, wherein the dedicated SL control signal includes a trigger indication for triggering the second UE to send a second SL PRS to the first UE.

14. The method of claim 10, further comprising:
transmitting, by the first UE to the second UE, an SL signal, wherein a transmission power of the SL signal is based on a received power of a previous SL PRS received by the first UE from the second UE.

15. The method of claim 10, further comprising:
receiving, by the first UE, a measurement report, the measurement report indicating a relative time difference based on measurement of SL PRSs and a synchronization source type; and
performing, by the first UE, sidelink positioning based on the relative time difference indicated by the measurement report.

16. The method of claim 10, wherein the SL PRS transmissions comprise a comb SL PRS transmission on every multiple resource elements (Res) in the frequency domain.

17. An apparatus, comprising:
at least one processor; and
a non-transitory computer readable storage medium storing a computer program code, the computer program code including instructions that, when executed by the at least one processor, cause the apparatus to perform operations including:
receiving a sidelink (SL) transmission that comprises one or more of dedicated SL control signals and one or more corresponding SL positioning reference signals (PRSs) over resources in a dedicated resource pool, wherein the dedicated resource pool is dedicated for physical sidelink control channel (PSCCH) and SL PRS transmissions; and
measuring the one or more corresponding SL PRSs.

18. The apparatus of claim 17, wherein each pair of a dedicated SL control signal and a corresponding SL PRS from the one or more dedicated SL control signals and the one or more corresponding SL PRSs is sent by a different corresponding transmitting user equipment (UE).

19. The apparatus of claim 17, wherein the SL transmission is received in a slot that comprises one or more PSCCHs mapped to the one or more corresponding PRSs, wherein resource allocation of the one or more PSCCHs is associated with resource allocation of the one or more corresponding SL PRSs.

20. The apparatus of claim 19, further comprising:
determining a first SL PRS resource for receiving a first SL PRS from a first UE based on mappings between the one or more PSCCHs and the one or more corresponding SL PRSs and based on a first PSCCH resource for receiving a first PSCCH of the one or more PSCCHs from the first UE.
